(19) United States
(12) Patent Application Publication
(10) Pub. No.: US 2013/0048471 A1
(43) Pub. Date: Feb. 28, 2013

(54) Wood Veneer Diverter and Processing System

(71) Applicant: J. T. Capps, JR., Huntington, TX (US)

(72) Inventor: J. T. Capps, JR., Huntington, TX (US)

(73) Assignee: GEORGIA-PACIFIC WOOD PRODUCTS LLC, Atlanta, GA (US)

(21) Appl. No.: 13/595,385

(22) Filed: Aug. 27, 2012

Related U.S. Application Data
(60) Provisional application No. 61/529,892, filed on Aug. 31, 2011.

(51) Int. Cl. B65G 15/58

(52) U.S. Cl. 198/692

(57) ABSTRACT

Apparatus, systems, and methods for transporting a wood veneer are provided. The apparatus can include a belt. A plurality of spikes can extend from a first side of the belt. The plurality of spikes can be configured to detachably engage with a wood veneer.

### BACKGROUND

1. Field

Embodiments described herein generally relate to apparatus, systems, and methods for handling wood veneer. More particularly, such embodiments relate to apparatus, systems, and methods for transporting veneer.

2. Description of the Related Art

A typical green veneer line includes a lathe, transport trays, a clipper scanner, a clipper, a veneer sheet diverter, a veneer sheet stacker, strip trays, a manual pull conveyor, and a trash haulback conveyor. The lathe peels a veneer layer or ribbon off of a log at a given peel thickness, e.g., approximately 0.125 inches thick until the log diameter is reduced to a “core” size limit. At that point, the core is removed from the lathe and a new log is inserted for peeling. The veneer ribbon can have a width about the same width as the log (usually about 102+/−inches when used to produce a 4 foot×8 foot plywood to allow for some trim). The length of the veneer ribbon can be dependent, at least in part, on the particular thickness of the veneer ribbon and the number of revolutions of the log required to reduce the original log diameter to the core diameter, removing 2 times the peel thickness from the diameter on each revolution. The veneer ribbon can then be transported or moved down a belt conveyor toward the clipper scanner.

The clipper scanner can monitor the veneer ribbon with a camera and the images from the camera can be processed by a computer to find defects in the veneer such as bark, voids where there is no wood, splits, knots, etc. The computer can determine where to clip or cut the veneer ribbon so as to maximize the value of the resulting pieces of veneer cut from the veneer ribbon. The location of the cuts or clips can depend upon criteria established by each individual mill, but the resulting cuts can produce different types or categories of material. The main types of veneer can include, but are not limited to, trash, fishtail, random, and/or full sheets. There can be other main types and subtypes of veneer. Another type or category of the veneer can include, for example, the particular type of wood. The veneer classified as “trash” veneer is not usable or preferred for use in making plywood and is typically transported to a hog shredder to be made into wood chips. The veneer classified as “fishtail” veneer includes pieces of veneer that lacks enough wood (e.g., less than approximately 102 inches for the production of a 4 foot×8 foot plywood sheet) along the grain direction to use in the long direction of the plywood (the 8 foot direction of a 4 foot×8 foot plywood), but enough wood (approximately 51 inches or more, when to be used in a 4 foot×8 foot plywood) to cut the piece such that it can be used as to form the plywood core in the short direction of the plywood (the 4 foot direction in a 4 foot×8 foot plywood). The veneer classified as “random” veneer includes pieces that are full length of the peel in the long direction (e.g., the 102+/−inch direction for a 4 foot×8 foot plywood), but less than the full width (e.g., approximately 54 inches in the case of a 4 foot×8 foot plywood, to allow for trim) in the other direction. The veneer classified as “full sheet” veneer includes pieces that span a full sheet of plywood and, for 4 foot×8 foot plywood, are nominally 54 inches wide by the full length, nominally 102 inches. The cuts or clips are in the wood grain direction and in a direction perpendicular to the width direction of the veneer (e.g., about 54 inches wide for veneer used for making a 4 foot×8 foot plywood). Fishtail veneer can be any width up to a full sheet width, and trash veneer can be any width depending on the defects that need to be removed.

After the pieces are clipped, in a conventional process, the clipped veneer pieces are transferred from the clipper onto a beltway, and removed from the beltway using a diverter. The pieces are sorted by the diverter onto respective beltways according to the type of material.

Although veneer diverters exist, a need still exists for improvements in veneer handling systems, in diverters for such systems as well as in components of such diverters, and in methods of diverter operation. A need also exists for improved apparatus, systems, and methods for transporting veneer and/optionally sorting the veneer into two or more categories.

### SUMMARY

Apparatus, systems, and methods for transporting a wood veneer are provided. The apparatus can include a belt. A plurality of spikes can extend from a first side of the belt. The plurality of spikes can be configured to detachably engage with a wood veneer.

The wood veneer transporting system can include a diverter body having one or more belts configured to move in a veneer flow direction. Each belt can include first and second opposing sides, where a first and second end of the belt can be coupled to one another to provide a continuous belt. The belt can also include a plurality of spikes extending from the first side thereof. The plurality of spikes can be configured to detachably engage with a wood veneer. The system can also include one or more veneer engaging diverters each rotatably coupled to the diverter body. Each veneer engaging diverter can rotate in the veneer flow direction and can include at least one projection extending therefrom and rotatable into and out of a veneer flow path. The projection can engage a wood veneer traveling in the veneer flow direction when the projection is at least partially located in the veneer flow path.

The method for transporting a wood veneer can include attaching a wood veneer to one or more spikes extending from a first side of one or more belts. The one or more belts can be moved to transfer the wood veneer from a first location to a second location.

### BRIEF DESCRIPTION OF THE DRAWINGS

FIG. 1 depicts a perspective view of a wood handling system, according to one or more embodiments described.

FIG. 2 depicts a side elevational view a wood handling system similar to the embodiment shown in FIG. 1, but without a frame and further illustrating an exemplary set of veneer transportation conveyors, according to one or more embodiments described.

FIG. 3 depicts a perspective view of a diverter body portion of the wood handling system shown in FIG. 1, according to one or more embodiments described.

FIGS. 4, 4A, and 4B depict a front, side, and top view, respectively, of an illustrative spike that can be used in the wood handling system shown in FIG. 1, according to one or more embodiments described.

FIG. 5 depicts an illustrative pinch belt assembly that can be used in the wood handling system shown FIG. 1, according to one or more embodiments described.

FIGS. 5A and 5B depict an illustrative pinch belt assembly that is movable from an operating position shown in FIG. 5A to a standby or maintenance or clearance position shown in FIG. 5B, according to one or more embodiments described.

FIG. 6 depicts an enlarged view of a portion of the diverter body shown in FIG. 3 showing one set of a plurality of diverters mounted to a support shaft and a motor for rotating the support shaft, according to one or more embodiments described.

FIG. 7 depicts an enlarged view of an illustrative set of diverters mounted to a support shaft, according to one or more embodiments described.

FIG. 8 depicts an enlarged view of a single diverter of the type shown in FIG. 7.

FIG. 9 depicts a side elevational view of the diverter shown in FIG. 8.

FIG. 10 depicts an enlarged view of an illustrative diverter positioned in a veneer flow path, according to one or more embodiments described.

FIG. 11 depicts a side elevational schematic view of another illustrative wood handling system utilizing a vacuum to hold pieces of veneer in engagement with belts, according to one or more embodiments.

FIGS. 12A-12F depict the operation of an illustrative diverter as the diverter is shifted into a position in a veneer flow path and stopped in the veneer flow path to divert a piece of veneer from the veneer flow path and away from a belt, according to one or more embodiments described.

FIGS. 13A-13G depict the operation of another illustrative diverter, according to one or more embodiments described.

FIG. 14 depicts an illustrative control approach for a wood veneer handling system and diverter, according to one or more embodiments described.

### DETAILED DESCRIPTION

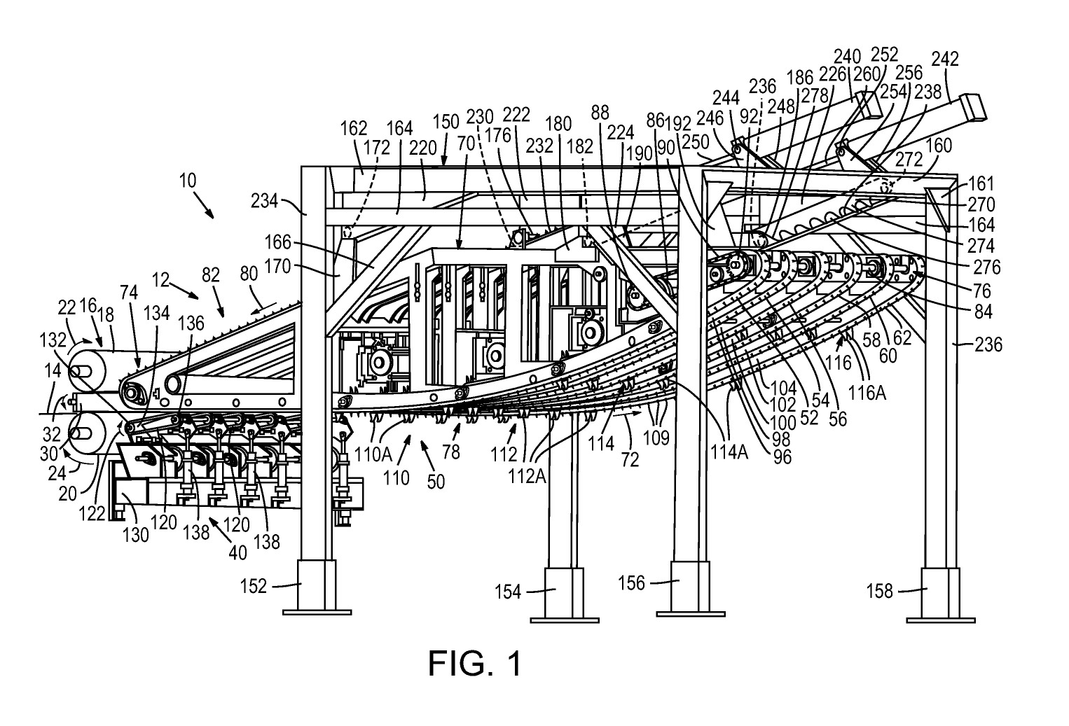

With reference to FIGS. 1-3, the wood handling system 10 can include a veneer sorting diverter 12. In the embodiment shown in FIG. 1, which does not depict various conveyors that can be included in a wood handling system for convenience in illustration, a ribbon of veneer peeled from a log (not shown) can be carried by an end feed conveyor 14 to a clipper 16. The clipper 16 can include a conventional veneer clipper having upper and lower rolls 18, 20 supported for rotation in the respective directions indicated by arrows 22, 24. A clipper blade 30 can be rotatably supported between the rolls 18, 20 for selective rotation in the direction of arrow 32 to clip or cut the veneer ribbon. For example, the selective rotation of the clipper blade 30 in the direction of arrow 32 can be response to one or more clipper control signals output from a scanner controller (not shown). The clipper blade 30 can rotate from a horizontal to a vertical position to clip the veneer with the clipper blade 30 extending between the two rollers when in the clipped position. A pinch belt assembly 40 can convey or transfer the clipped veneer from the clipper 16 to one or more belts (six are shown, 52, 54, 56, 58, 60 and 62) of a diverter assembly 50. The pinch belt assembly 40 can be eliminated in some embodiments, such as in vacuum embodiments wherein a vacuum is used to hold the veneer pieces in engagement against veneer transporting belts of the diverter assembly 50.

The plurality of belts 52, 54, 56, 58, 60, and 62 can be transversely spaced apart loop belts. Said another way, a first and second ends of the plurality of belts 52, 54, 56, 58, 60, and 62 can be coupled to one another to provide a continuous belt. Although not shown, in another example the first and second ends any one or more of the belts 52, 54, 56, 58, 60, and 62 can be uncoupled or not connected to one another. The belts 52, 54, 56, 58, 60, and 62 can be supported by a diverter assembly body 70 for travel in a veneer flow direction indicated by arrow 72 from an entrance end portion 74 of the diverter assembly body 70 toward an exit end portion 76 of the diverter assembly body 70. The belts 52, 54, 56, 58, 60, and 62 can travel in the direction of arrow 72 along a lower or bottom portion 78 of the diverter assembly body 70 and in the opposite direction, indicated by arrow 80, along an upper or top portion 82 of the diverter assembly body 70. One or more shafts and/or pulleys can be used to support one or more of the belts 52, 54, 56, 58, 60 and 62 and/or maintain the belts in alignment. For example, a rotatable shaft 84 at end portion 76 of the diverter assembly body 70 can carry a plurality of pulleys, not shown, for receiving the respective belts 52, 54, 56, 58, 60, and 62. The shaft 84 can be journaled or supported by one or more bearings to a portion of a framework of the diverter assembly body 70. Although other veneer transporting belt drive mechanisms can be used, in one specific example, a motor 86 can rotate a drive gear 88 coupled by a chain or belt 90 to a drive gear 92 mounted to the shaft 84. The motor 86 can be operated to drive the gears 88, 92 to in turn or rotate the shaft 84 and move the belts 52, 54, 56, 58, 60, and 62 in the desired direction, such as in direction 72 along the bottom surface of the diverter assembly body 70. The terms “belt” and “belts,” as used herein, is to be broadly construed to include an elongated member. Illustrative elongated members can include, but are not limited to, straps, cables, ropes, chains, or any combination thereof.

The one or more belts 52, 54, 56, 58, 60, and 62 can include one or more holes or apertures defined therethrough and/or therein. For example, in the case of a vacuum system, one or more of the belts 52, 54, 56, 58, 60, and 62 can include one or more apertures or holes configured to permit application of the vacuum through the belt to veneer pieces held against the belts by the vacuum. In another example, in the case of a “spike” belt system, one or more of the belts 52, 54, 56, 58, 60, and 62 can include a one or more apertures or holes defined therein configured to at least partially receive one or more spikes 109. For example, the one or more spikes 109 can be disposed through the one or more apertures or holes defined in the belts 52, 54, 56, 58, 60, and 62 and secured thereto and an end of the spikes 109 can at least partially penetrate the veneer thereby holding the veneer about the belts 52, 54, 56, 58, 60, and 62. In another example, in the case of a spike belt system, one or more of the belts 52, 54, 56, 58, 60, and/or 62 can be a solid or continuous body free from one or more apertures. The one or more spikes can be fixed or otherwise secured to a surface of the belts such that an end of the spikes can at least partially penetrate the veneer thereby holding the veneer about the belts 52, 54, 56, 58, 60, and 62. In another example, the one or more spikes 109 can extend from one or more of the belts 52, 54, 56, 58, 60, and/or 62, and can be moveable with respect to the belts 52, 54, 56, 58, 60, and/or 62. For example, the spikes 109 can extend from the surface of the belts 52, 54, 56, 58, 60, and/or 62 when in a first position and can be retracted in a second position. In one example, when in the second position a tip of the spikes 109 can extend from the surfaces of the belts 52, 54, 56, 58, 60, and/or 62 a distance less than a thickness of a veneer to be transported via the belts 52, 54, 56, 58, 60, and/or 62. In another example, when in the second position or retracted position the tips of the spikes 109 can be flush or below the surfaces of the belts 52, 54, 56, 58, 60, and/or 62. The spikes 109 can be moved from the first or extended position to the second or retracted position using any suitable device, system, or combination of systems and devices. For example, the spikes 109 can be a piston or rod that moves via pneumatic or hydraulic actuations within a cylinder. In another example, the spikes 109 can be coupled to and actuated between the first and second positions via an electric motor.

Considering the one or more belts 52, 54, 56, 58, 60, and 62 in more detail, each belt 52, 54, 56, 58, 60, and 62 can be the same or different with respect to one another. The belts 52, 54, 56, 58, 60, and 62 can be made of metals, metal alloys, non-metallic material, synthetic materials, non-synthetic materials, and combinations thereof. Illustrative materials can include, but are not limited to, polyester, nylon, polyethylene, polypropylene, para-aramid synthetic fiber (e.g., KEVLAR®), high-performance polyethylene (“HPPE”), ethylene propylene diene monomer (“EPDM”), organic fibers, metals, metal alloys, and any combinations thereof. In another example, one or more of the belts 52, 54, 56, 58, 60, and 62 can be or include one or more metal cables or straps, optionally, coated with one or more non-metallic materials.

The belts 52, 54, 56, 58, 60, and 62 can have a width, i.e., the length between the two opposing sides or edges, ranging from about 0.5 cm to about 20 cm. For example, the belts 52, 54, 56, 58, 60, and 62 can have a width ranging from a low of about 0.5 cm, about 1 cm, about 1.5 cm, about 2 cm, about 2.5 cm, about 3 cm, or about 3.5 cm to a high of about 5 cm, about 6 cm, about 7 cm, about 8 cm, about 9 cm, about 10 cm, about 11 cm, about 12 cm, about 13 cm, about 14 cm, about 15 cm, or more. For example, the width of the belts 52, 54, 56, 58, 60, and 62 can range from about 3.7 cm to about 8.3 cm, or about 4 cm to about 6 cm, or about 4.5 cm to about 5.5 cm. The belts 52, 54, 56, 58, 60, and 62 can have a thickness, i.e., the length between first and second opposing sides of the belts, ranging from about 0.2 cm to about 1.3 cm. For example, the belts 52, 54, 56, 58, 60, and 62 can have a thickness ranging from a low of about 0.3 cm, about 0.4 cm, or about 0.5 cm to a high of about 0.7 cm, about 0.9 cm, or about 1.1 cm. In another example, the thickness of the belts 52, 54, 56, 58, 60, and 62 can range from about 0.3 cm to about 1.3 cm, about 0.4 cm to about 0.9 cm, or about 0.8 cm to about 1.1 cm.

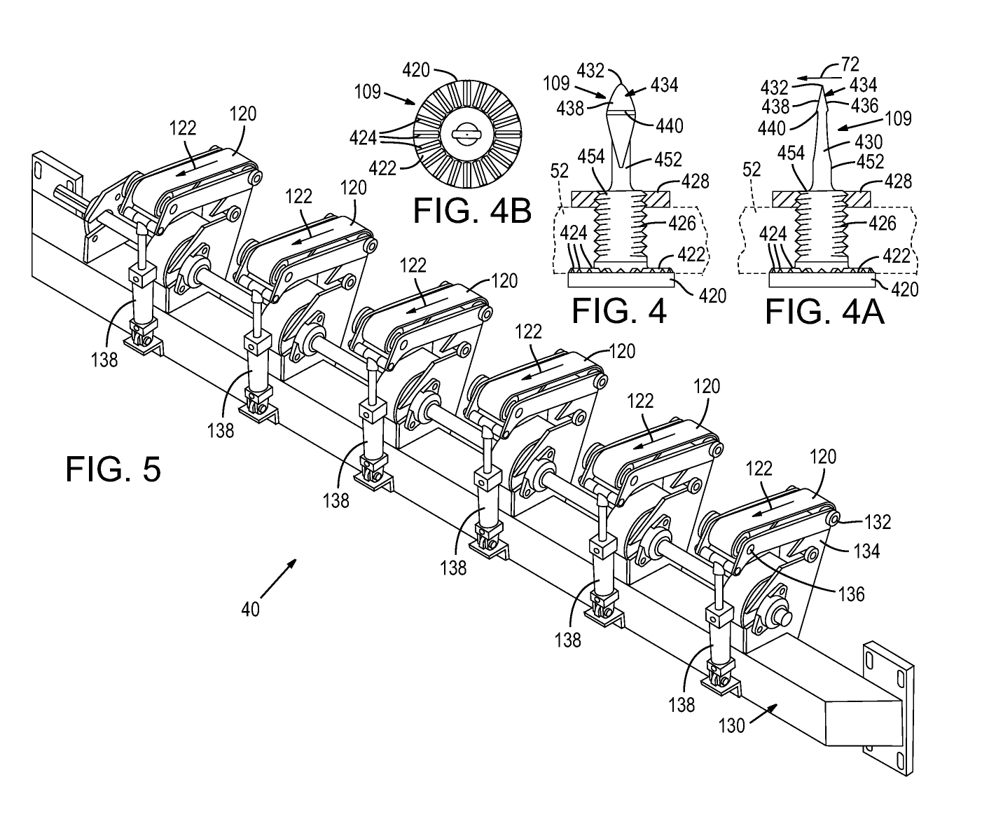

As depicted in FIG. 1, gaps or spaces can be provided between the respective belts 52, 54, 56, 58, 60, and 62. For example, a gap 96 is shown between belts 52 and 54, a gap 98 is shown between belts 54 and 56, a gap 100 is shown between belts 56 and 58, a gap 102 is shown between belts 58 and 60 and a gap 104 is shown between belts 60 and 62. Unlike a vacuum system, the belts 52, 54, 56, 58, 60, and 62 shown in FIG. 1 each include a plurality of spikes 109 extending from a first side of or outwardly from the belts and spaced apart along the length of the belts. The length of the gaps 96, 98, 100, 102, and 104 between the respective belts 52, 54, 56, 58, 60, and 62 can be the same or different with respect to one another. Suitable spikes 109 can be as discussed and described below with reference to FIGS. 4, 4A, and 4B.

The spacing between any two adjacent spikes 109 can be the same or different with respect to any two other adjacent spikes. The spacing between any two adjacent spikes 109 can range from a low of about 0.5 cm, about 1 cm, about 1.5 cm, about 2 cm, about 2.5 cm, or about 3 cm to a high of about 6 cm, about 7 cm, about 8 cm, about 9 cm, or about 10 cm. For example, any two adjacent spikes 109 can be spaced apart a distance of about 3.7 cm, about 4 cm, about 4.3 cm, about 4.7 cm, about 5 cm, about 5.3 cm, about 5.7 cm, about 6 cm, or about 6.3 cm. In another example, any two adjacent spikes 109 can be spaced apart along a given belt 52, 54, 56, 58, 60, and/or 62 a distance of about 3.5 cm to about 7 cm, about 4 cm to about 6 cm, about 4.5 cm to about 5.5 cm, or about 4.7 cm to about 5.3 cm. In at least one specific embodiment, spikes 109 along a given belt 52, 54, 56, 58, 60, and/or 62 can be spaced apart a distance of about 5 cm.

Although a single row of spikes 109 are depicted in FIG. 1 as being longitudinally disposed along a length of the belts 52, 54, 56, 58, 60, and 62 any number of rows of spikes 109 can be disposed along the length of the belts 52, 54, 56, 58, 60, and 62. For example, each belt can include a single row, two, three, four, five, or more rows of spikes 109 disposed along the length thereof. The number of rows of spikes disposed along the length of any two belts 52, 54, 56, 58, 60, and 62 can be the same or different with respect to one another. In another example, the spikes 109 can be staggered with respect to one another along the length of the belts 52, 54, 56, 58, 60, and 62.

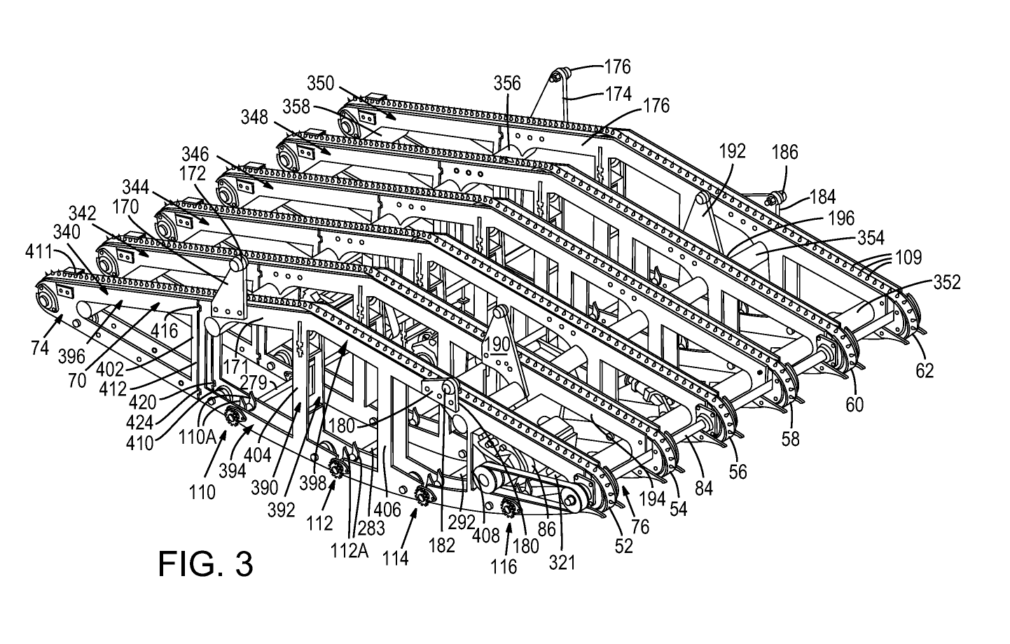

One or more sets of veneer engaging diverters can be carried by, supported, or otherwise disposed about the diverter assembly body 70. For example, as shown in FIG. 1, the wood handling system 10 can include four sets of veneer engaging diverters 110, 112, 114, and 116. In the FIG. 1 embodiment, the first set of veneer engaging diverters 110 can include a plurality of transversely spaced apart veneer diverters, two of which are indicated by the number 110A. Also, the second set of veneer engaging diverters 112 can include a plurality of transversely spaced apart veneer diverters, two of which are indicated by the number 112A. In addition, the third set of veneer engaging diverters can include a plurality of transversely spaced apart veneer diverters, two of which are indicated by the number 114A. Also, the fourth set of veneer engaging diverters can include a plurality of transversely spaced apart veneer diverters, two of which are indicated by the number 116A. The veneer diverters can be positioned between the belts 52, 54, 56, 58, 60, and/or 62 and can be rotatable into the veneer flow path during operation of the veneer diverters, as further discussed and described below, to dislodge veneer impaled or otherwise secured to the spikes 109 of the belts 52, 54, 56, 58, 60, and/or 62 and/or held against the belts 52, 54, 56, 58, 60, and/or 62 by a vacuum. One or more of the sets of veneer engaging diverters can include a one or more diverters positioned in any one or more of the gaps 96, 98, 100, 102, and/or 104. For example, as shown in FIG. 3, two veneer diverters 112A of set 112 can be positioned on either side of the belt 52 so that the two veneer diverters 112A can extend into the veneer flow path as the belt 52 travels. As also can be seen in FIGS. 1 and 3, the veneer diverters of each set can be oriented in alignment with respect one another. As further discussed and described below, in response to control signals, the veneer diverters of the respective sets can be moved into, stopped within, and/or moved out of the veneer flow path and can be configured such that when stopped in the veneer flow path they can divert, direct, or otherwise urge veneer away from the belts 52, 54, 56, 58, 60, and/or 62. In the case of a vacuum system, any gap between veneer diverters can be at least partially closed by a baffle once the veneer is urged away therefrom to minimize or reduce the possibility of the vacuum drawing the veneer back against the belts after being dislodged by the veneer diverters.

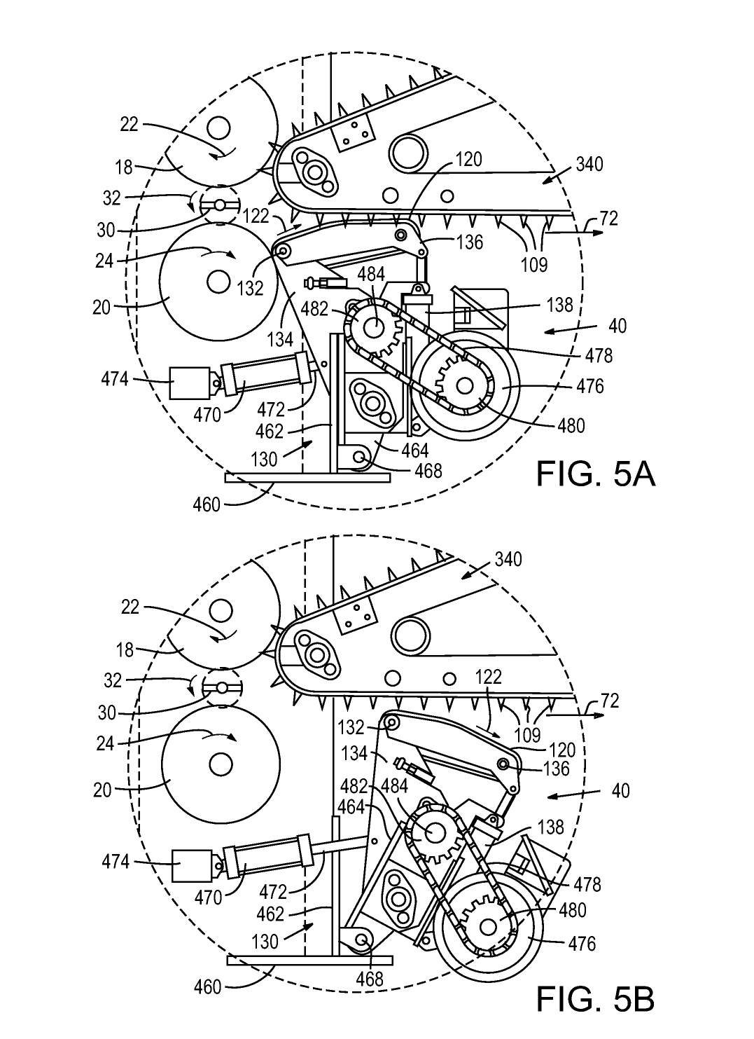

As shown in FIG. 1, the pinch belt assembly 40 can include, but is not limited to, six pinch belts, two of which are numbered by reference numerals 120 in FIG. 1. The pinch belts 120 can be driven by an actuator such as a motor (in the direction of arrow 122). Although not required, a single common motor can be used to move all of the pinch belts 120. The pinch belt assemblies 40 can be pivoted at one end portion 132 (FIGS. 5, 5A) to a respective upwardly extending support portion 134 carried by a pinch belt assembly supporting structure or frame 130. This can allow some upward and downward movement of the distal end portion 136 of the pinch belt assembly 40. A cylinder 138 coupled to a distal end portion of each pinch belt assembly 40 can provide for downward movement of the distal end portion to increase a gap between the belts of the pinch belt assembly and veneer transporting belts 52, 54, 56, 58, 60, and/or 62 to, for example, permit the passage of debris or clumps of veneer material. In FIG. 5A, cylinder 138 is shown in its extended position that places the pinch belts 120 in position to urge veneer against the spikes 109 of the belts 52, 54, 56, 58, 60, and/or 62.

In the case of a diverter with belts 52, 54, 56, 58, 60, and/or 62 having one or more spikes 109 extending therefrom, as shown in FIG. 1, the pinch belt assemblies 40 can urge veneer traveling from the veneer clipper 16 against the spikes 109 extending from the belts 52, 54, 56, 58, 60, and/or 62 to impale veneer on the spikes 109. When veneer is peeled from a log, the lengthwise direction of the veneer can substantially correspond to the transverse direction of the veneer diverter. In addition, the spikes 109 can be oriented to follow the grain of the veneer when the veneer is impaled or otherwise contacted with the spikes 109. In the case of a vacuum system, the pinch belt assemblies 40 can be eliminated as the vacuum can draw the veneer pieces against the belts 52, 54, 56, 58, 60, and/or 62. However, in an alternative construction the pinch belt assemblies 40 can still be utilized in a vacuum system. In an embodiment described below, the pinch belt assembly supporting structure 130 can be constructed so as to be pivotal about a transverse axis relative to an upright support to allow pivoting of the group of pinch belt assemblies 40 away from the clipper to provide access to the clipper.

As shown in FIG. 1, the diverter assembly body 70 can be carried or supported by a frame indicated generally by the number 150. The frame 150 can include four spaced apart posts 152, 154, 156 and 158. In the form shown, the posts 152, 154 can be positioned at respective opposite sides of the diverter assembly body 70 nearer to the front end 74 of the diverter body than the rear end 76. In addition, posts 156, 158 can be positioned along opposite sides of the diverter assembly body 70 near the rear end 76 of the diverter assembly body 70. The diverter assembly body 70 can be positioned between the posts. Transversely extending cross members, one being indicated at 160 in FIG. 1, can connect the upper ends of the respective posts 152, 154 and posts 156, 158. Gussets, such as 161, can reinforce the interconnection between the upright post and transverse frame components. An upper longitudinally extending frame component 162 can extend between posts 152 and 156. A similar frame component can extend between the upper ends of posts 154, 158 on the opposite side of the frame. In addition, lower frame components 164 can extend between the respective posts 152, 156 and posts 154, 158 at a location below the upper frame components 162. Reinforcing gusset pieces, such as one numbered as 166 in FIG. 1, can extend between the respective posts and lower cross members.

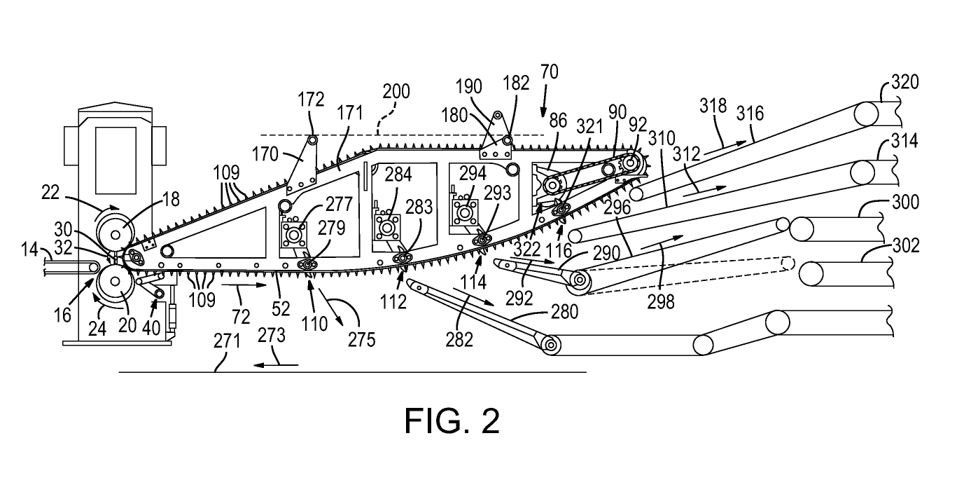

The diverter body assembly 70 can be supported from the frame 150 in any suitable manner. In one desirable approach, as best seen with reference to FIGS. 2 and 3, a first support bracket 170 can be mounted to an outer side surface of an upper diverter body frame member 171 and terminate at a distal end portion to which a roller 172 can be mounted for rotation about a horizontal axis. A second upright support bracket 174 (FIG. 3) can be mounted to an outer surface of a frame member 176 of the diverter body 70 at the opposite side of the diverter body from frame member 171. Bracket 174 can terminate in a distal end portion to which a roller 176 can be rotatably mounted for rotation about a horizontal axis. Desirably the rollers 172, 176 can be directly opposed to one another. In addition, an upright bracket 180 can be mounted to the member 171 and supports a roller 182 desirably rotatable about a transverse horizontal axis. A similar bracket 184 mounted to the member 176 can carry a roller 186 desirably mounted for rotation about a transverse horizontal axis. Desirably the rollers 182, 186 can be opposite to one another. The rollers 172, 176, 182 and 186 can suspend the diverter body 70 from the frame 150 as further discussed and described below. In addition, upright moving element coupling brackets 190, 192 can project upwardly from respective frame components 194, 196 (FIG. 3) of the diverter assembly body 70. The functioning of these brackets will become apparent from the description below. As can be seen in FIG. 2, desirably the rollers 172, 182 can be positioned in a horizontal plane 200 when the diverter body is installed on the frame as shown in FIG. 1. Similarly, the rollers 176, 186 can be in the same plane 200.

With reference to FIG. 1, the frame 150 can include a first and second rear ramp defining members 220, 222 and first and second front ramp defining members 224, 226. The members 220, 222 can be the same or different with respect to one another. In addition, the members 224, 226 can also be the same or different with respect to one another. Consequently, only members 222 and 226 will be described. Support 222 can include an inwardly directed shelf that can be in the form of a roller receiving channel that, in the embodiment of FIG. 1, can include a first support portion 230 that can be horizontal and an inclined portion 232 that can extend both inwardly and upwardly moving from the entrance end portion of the frame 234 to the exit end portion of the frame 236. The roller 176 is shown resting on the shelf portion 230 when the diverter body is supported in its operational position. A stop can be included at the entrance end portion of the shelf portion 230 to prevent the roller from rolling off of the shelf. In addition, support portion 226 can include a first shelf portion 236 that can be horizontal, and can be provided with a stop at the entrance end portion of the shelf and a ramp portion 238 inclined upwardly moving toward the exit end portion 236 of the frame. In response to force applied to the diverter assembly body 70, such as generally upwardly in a direction toward the exit portion 236 of the frame 150, the rollers 182, 186 can travel upwardly along their respective ramps (e.g., roller 236 can travel upwardly along ramp 238) and the rollers 176, 186 and 172, 182 can travel upwardly along their respective ramps (e.g., roller 176 can travels upwardly along ramp 232). As a result, the diverter body can be moved upwardly and away from the clipper 16. With this construction, the diverter body can be positioned very close to the clipper 16 as it can be moved out of the way when access to the clipper 16 is desired. Although different actuator mechanisms can be utilized to apply force to the diverter assembly body 70 to move the diverter assembly body 70 as just described, such as motors or other movement mechanisms, in the embodiment of FIG. 1, respective first and second cylinders 240, 242, which can be fluid cylinders such as hydraulic or pneumatic cylinders, can be supported by the frame 150 and coupled to the diverter assembly body 70. More specifically, the cylinder housing of cylinder 240 can be pivoted at pivot 244 to upright brackets 246, 248 to support cylinder 240. A cylinder rod 250 of cylinder 240 in this example can be pivotally connected to the upwardly projecting bracket 190 (FIG. 3). In the same manner, the cylinder housing of cylinder 242 can be pivoted at 252 to respective brackets 254, 256 extending upwardly from the frame. The cylinder rod 260 of cylinder 242 can be connected to the support 192 (FIG. 3). Retraction of the rods 250, 260 can move the rollers 172, 182 and 176, 186 up their respective ramps to move the diverter assembly body 70 as previously described.

As a safety mechanism, one or more engagable stops can be provided to engage the diverter body to prevent it from moving back down the ramp at undesired times. One such stop mechanism can be associated with each of the supports 224, 226. The stop mechanisms can be the same and therefore only the mechanism associated with support 226 is described in connection with FIG. 1. The illustrated stop mechanism can include an elongated body 270 pivoted at an end portion 272, spaced from roller 248, to the support 226 or to the frame 150. The body 270 can include a plurality of downwardly extending teeth, one of which is numbered as 274 in FIG. 1. A respective roller receiving recess 276 can be provided between each of the teeth 274. The walls bounding the recess, as shown, can be angled with the lower wall being generally perpendicular to the shelf and the upper wall being angled at an acute angle relative to the shelf. In addition, an angled ramp surface 278 can be provided at the lower end of the body 270. As the diverter assembly body 70 moves upwardly, roller 186 can engage ramp 278 and pivot the stop body 270 upwardly away from the shelf. As a roller enters the first recess, the roller (or a pin thereof) can be retained against downward movement (for example, if the cylinders 240, 242 were to fail) by the lower boundary of the recess. Continued movement of the diverter assembly body 70 upwardly can again raise the stop body 270 allowing the roller pin to move into the next recess and so on until the diverter body has been moved to its fully raised position. In order to allow lowering of the diverter assembly body 70, the stop can be pivoted upwardly away from the shelf so that the roller and/or roller pin clears the teeth 274 and the diverter body can be moved downwardly by the cylinders 240, 242.

With reference to FIG. 2, components of FIG. 2 that correspond to those of FIG. 1 have been assigned the same numbers as used in FIG. 1 and will not be discussed in detail. As can be seen in FIG. 2, the lower surface of the illustrated diverter assembly body 70 can be arcuate and more specifically convex such that the veneer flow path 72 of veneer impaled or other wise contacted by the spikes 109 (or held by a vacuum against the veneer transporting belts) also follows the arcuate path unless diverted by a respective set of diverters.

In the embodiment of FIG. 2, a first conveyor 271 is shown with the upper portion of the conveyor being movable in the direction indicated by arrow 273. Conveyor 271 can typically be a haulback or trash conveyor positioned to convey trash veneer to a hog or shredder for shredding the veneer into chips. Assuming that a scanner indicates that trash veneer has been clipped (e.g., a section of veneer containing a knot can clipped from a veneer ribbon by clipper 16 and impaled or otherwise contacted with the spikes 109 by the pinch belt assembly 40), the trash veneer can be moved in the direction of arrow 72 toward the first set of diverters 110. The first set of diverters 110 can be operated to divert trash veneer being moved by the diverter belts. More specifically, by moving the diverters of the first set of diverters 110 into the veneer flow path, as the veneer reaches the first set of diverters 110 that are stopped in the veneer flow path, the trash veneer engages the diverters and can be directed or otherwise urged, such as generally indicated by the arrow 273 away from the belts 52, 54, 56, 58, 60, and/or 62 and toward the trash conveyor 271. A motor 277 coupled to a diverter supporting shaft 279 in this embodiment can rotate the shaft and thus the diverters mounted thereto, about a transverse axis positioned above the veneer flow path. The diverters can be moved desirably in the veneer flow path direction (e.g., they are rotated counter clockwise in FIG. 2) such that the lower projecting portion of the diverters enter the veneer flow path at an upstream direction, travel in a downstream direction and leave the veneer flow path. By stopping the diverter in the flow path, the diverter can be located in a position to engage the veneer and direct or otherwise urge the veneer downwardly and away from the belts 52, 54, 56, 58, 60, and/or 62. Desirably, the first set of diverters 110 remain in their veneer diversion position until such time as another grade of veneer is indicated by a scanner as reaching or about to reach the first set of diverters 110. In this case the first set of diverters 110 can be pivoted out of the veneer flow path to allow the higher grade veneer to pass the first set of diverters 110.

Assuming that the second set of diverters 112 are controlled to divert fishtail veneer from the veneer flow path (this is simply an illustrative example as other grades of veneer could be diverted by the set of diverters 112). Also assume that a piece of fishtail veneer is about to reach the set of diverters 112. Again, if the set of diverters 110 are operated to divert trash veneer, the first set of diverters 110 would have been moved out of the veneer flow path to permit the fishtail veneer to pass. Under these conditions, the second set of diverters 112 can be moved, desirably in the veneer flow direction, into the veneer flow path, or remain in the veneer flow path if already there. As a result, when the fishtail veneer encounters the second set of diverters 112, the fishtail veneer can be diverted onto a conveyor 280 in a direction generally indicated by the arrow 282. The conveyor 280 can carry the fishtail veneer to a fishtail veneer collection location and/or to additional conveyors where the fishtail veneer can be manually pulled or further sorted. The diverters of the second set of diverters 112 can be mounted to a shaft 283 for rotating about a second diverter shaft axis positioned above the veneer flow path. A motor 284 can rotate the shaft 283 to selectively position the veneer diverters of the second set of diverters 112 in the veneer flow path as desired. Motors 276 and 284 can be responsive to motor control signals as further discussed and described below, as is the case for the other veneer diverter set controlling motors.

Assume that third set of diverters 114 is operable to divert random grade veneer from the belts 52, 54, 56, 58, 60, and/or 62. In this case, as the random grade veneer reaches the first and second sets of diverters 110, 112, these diverters can be moved out of the veneer flow path to allow the random grade veneer to pass. As the random grade veneer reaches the third set of diverters 114, the diverters of the third set of diverters 114 can be moved into the veneer flow path, or remain in the veneer flow path if already there, and can be stopped in a position to divert the random grade veneer downwardly away from the belts 52, 54, 56, 58, 60, and/or 62 and onto a conveyor 290 with the veneer generally traveling in the direction of arrow 292 on an initial portion of the conveyor 290. The veneer diverters of the third set of diverters 114 can be mounted to a shaft 293 extending transversely relative to the diverter assembly body 70, as can be the case of shafts 279, 283, with the shaft 293 being driven by a motor 294 in response to a motor control signal. The conveyor 290 can, for example, be coupled to a respective movable conveyor 296. The conveyor 296 can be movable from a first position shown in solid lines in FIG. 2 and a second position shown in dashed lines in FIG. 2. When the conveyor 296 is in the first position, the veneer can travel from conveyor 290 in the direction of arrow 298 to a conveyor 300 from where the veneer can be transported to a desired sorting or stacking location. When the conveyor 296 is in the second position, the veneer can travel from conveyor 290 to a conveyor 302 for transporting the veneer to a different location. For example, wider sized random grade veneer can be transported to conveyor 300 and narrower sized random grade veneer can be transported to conveyor 302.

In an exemplary three diverter set system, and assuming the first set of diverters 110 is operable to divert trash veneer, the second set of diverters 112 is operable to divert fishtail veneer, and the third set of diverters 114 is operable to divert random veneer, in the event full sized veneer is detected and reaches any one of the veneer diverter sets 110, 112 and 114, the diverters of these sets can be moved out of the veneer flow path to permit passage of the full sized veneer. The full sized veneer can be directed to a conveyor for carrying the veneer to a stacking or sorting location.

As another example such as shown in FIG. 2, a fourth set of diverters 116 can be provided that can (assuming the sets 110, 112 and 114 divert respective trash, fishtail and random veneer) further sort the full sized veneer. For example, assume that the fourth set of diverters 116 is operable to divert extremely wet veneer, such as sapwood veneer with the moisture content being detected, for example using a moisture detector not shown. In this example, the veneer diverter set can be operated as follows. As a full sized wet sapwood veneer sheet travels along the belts, the diverter sets 110, 112 and 114 can be moved out of the way to permit passage of the veneer. However, when the veneer reaches the diverters of the fourth set of diverters 116, the fourth set of diverters 116 can be positioned in the veneer flow path, or remain in the veneer flow path if already there, to divert the full sized wet sapwood veneer sheets to a conveyor 310 for travel in the direction of arrow 312 to a conveyor 314 for transportation to a stacking or further sorting area. If the full sized veneer s not a wet veneer, assuming the veneer diverters of set 116 are operable to divert wet veneer downwardly and away from the belt, when the veneer reaches diverters 116, the diverters can be moved out of the way if not already out of the way. This allows the full sized dry veneer to be transported to a conveyor 316 for travel in a direction of arrow 318 to a conveyer 320 for transportation to a stacker or other sorting location. The various conveyors can be replaced with other veneer handling devices such as stackers if desired. The diverters of the fourth set of diverters 116 can be mounted to a transverse shaft 321 rotatably coupled to the diverter assembly body 70 and driven in rotation by a motor 322 in response to motor control signals. Since sapwood is located on the outer layers of a log, assuming the diverters of the fourth set of diverters 116 are operable to divert full sheets of sapwood veneer from the veneer flow path, once sapwood is detected the veneer diverters of the fourth set of diverters 116 can be maintained in the diversion position continuously until such time as heart wood veneer or drier veneer is detected. Once drier veneer is detected, the remaining veneer peeled from the log should also be dry. Therefore, the diverters of set 116 can be moved out of the diverter flow path once dry wood peeled from the log reaches the position of the fourth set of diverters 116 until the next time a new log is positioned for peeling.

Although not shown in FIG. 2, the any one or more of the sorted veneer pieces, e.g., the fishtail veneer via conveyor 289, random veneer via conveyors 300 and/or 302, wet sapwood veneer via conveyor 314, and/or dry veneer via conveyor 320, can be further moved or transported via another belt or plurality of belts having spikes 109 extending therefrom (not shown). For example, the dry veneer transferred onto the conveyor 320 can be transferred from the conveyor 320 onto one or more other or “second” belt (not shown). As such, the wood handling system 10 can further include one or more other or “second” pinch belt assemblies (not shown) that can be similar to the pinch belt assembly 40 discussed above or elsewhere herein. The second pinch belt assembly can convey or transfer the dry veneer from conveyor 320 to the one or more other or second belts. The one or more other or second belts can be similar to the belts 52, 54, 56, 58, 60 and 62 discussed and described above or elsewhere herein. Accordingly, the sorted veneer pieces on conveyors 280, 300, 302, 314, and/or 320 can be further transported via one or more belts having spikes extending therefrom similar to the belts 52, 54, 56, 58, 60 and 62 discussed and described in FIGS. 1-3. The wood handling system 10 can further include one or more sets of diverters, i.e., a fifth set of diverters (not shown), that can be similar to the first, second, third, and fourth sets of diverters 110, 112, 114, and 116, respectively. Similarly, the veneer pieces diverted to conveyor 271 can also be further transported via one or more other belt systems (not shown) having one or more spikes extending therefrom.

With reference to FIG. 3, the belts 52, 54, 56, 58, 60, and/or 62 are shown being driven by motor 86 coupled by pulleys and a belt to the shaft 84. This is simply another example of a suitable drive mechanism for the diverter belts.

The diverter body illustrated in FIG. 3 can include a plurality of generally triangular truss-like structures with an arcuate base. Since these structures can be the same, only one of these structures is described below. In the embodiment of FIG. 3, there are six truss structures 340, 342, 344, 346, 348 and 350 interconnected by a plurality of transversely extending cross members, such as four such tubular members 352, 354, 356 and 358. Since the truss structures of the diverter assembly body 70 can be the same, only structure 340 will be described. The illustrated structure 340 can include first and second side wall portions 390, 392 that can be interconnected by reinforcing spacers. Since these side members can be mirror images of one another, only side member 390 will be described in detail. The member 390 can include a lower arcuate cord portion or base portion 394 and first and second upper sections 396, 398. Upper section 396 can join the end of the base portion 394 adjacent to end 74 of the truss structure. Portion 398 can join the end of the base 394 adjacent to end 76 of the diverter assembly body 70. The sections 396, 398 can meet at a location 400 intermediate to the ends 74, 76 of the diverter assembly body 70. Spaced apart upright frame portions 402, 404, 406 and 408 can extend between the base portion 394 and the sections 396, 398. Upright frame portion 408 can be narrower than the corresponding uprights of the other truss sections to provide clearance for a diverter belt drive mechanism. Belt guide pulleys, one being indicated at 410 in FIG. 3, can be rotatably supported between the inner and outer side sections 390, 392 for guiding the associated transporter belt as it moves. The peripheral edges of the upper and base sections of the respective inner and outer support members 390, 392 can extend upwardly along the sides of the diverter belt to guide the movement of the diverter belt. A belt retainer, such as one being numbered as 411 in FIG. 3, can be provided in association with each truss structure to assist in retaining the belt on its associated belt supporting structure. In addition, to facilitate transportation of the diverter assembly body 70, the sections 394, 396 and upright 402 can be split along a seam interface 412. Mating features, such as interfitting projections and recesses 414, 416 in the respective base section 394 and upper section 396 can be provided for purposes of aligning the sections of the diverter assembly body when assembled and to provide a stronger connection of the diverter assembly body 70. These components can be bolted together when the structure is assembled, or otherwise interconnected, for example, by welding.

FIGS. 4, 4A and 4B depict an illustrative spike 109 that can be installed or otherwise secured to one or more of the belts 52, 54, 56, 58, 60, and/or 62 (see FIG. 1). As shown in FIG. 4, the spike 109 can include a base 420. The base 420 can include a surface 422. The surface 422 can be smooth, variable, or a combination thereof. An illustrative variable or friction enhanced surface 422 can be or include a knurled surface as shown by knurls 424 in FIG. 4B. Other friction enhanced surface configurations or topographies can include, but are not limited to, dimples, protrusions, projections, protuberances, ridges, depressions, grooves, holes, notches, recesses, bumps, channels, or any other surface variation or modification, either alone or in any combination. The spike 109 can include a shank 426 that can extend from the base 420. The shank 426 can be centrally disposed on and extend from the base 422. As shown, the shank 426 can include one or more threads disposed on an outer surface thereof. Although not shown, the shank 426 can be smooth and/or include other surface modifications in addition to or in lieu of the one or more threads such as barbs, ridges, and the like. The shank 426 can be inserted through an aperture, hole, or other opening such as a slot defined in the belt, e.g., belt 52. A fastening device or fastener 428 can detachably secure the spike 109 to the belt 52. For example, an end or tip 432 of the spike 109 can be disposed through the aperture defined by the belt 52 and the base 420 can engage a first side of the belt 52. The fastener 428 can then be secured to the shank 426 of the spike 109. Illustrative fasteners 428 that can be used to secure the spike 109 to the belt can include, but are not limited to, nuts, rivets, pins, e.g., cotter pins, or any other fastener that can either detachably or permanently engage with the shank 426. Although not shown, one or more washers, e.g., a flat washer and/or a lock washer, can be disposed between the belt and the fastener 428. Although not shown, in another example the belt, e.g., belt 52, can include a base plate or other structure disposed therein and/or thereon capable of threadably engaging with the shank portion 426. In another example, the shank 426 can threadably engage with an inner wall or surface of the aperture defined by the belt 52 within which the shank 426 can be at least partially disposed.

With reference to the embodiment shown in FIG. 4A, the spike 109 can include an impaling portion 430 projecting upwardly from the shank 426. The impaling portion 430 can terminate or include the end or tip 432. The spike 109 can transition to an upper veneer contacting portion 434 between the tip 432 and the impaling portion 430. The contacting portion 434 can impale or penetrate the veneer. The tip 432 with the contacting portion 434 can include converging surfaces 436, 438 that converge moving upwardly toward the tip 432. The surfaces 436, 438 can converge inwardly toward one another moving in a direction away from the tip (at a location 440). The spike 109, as shown in this example, thus, in effect can include a veneer retaining recess or barb at the location 440. Surfaces 436, 438 moving from the location 440 downwardly toward the threaded shank 426 can diverge to a location 452 intermediate the location 440 and an upper surface 454 of the shank 426. The enlarged cross sectional area at location 452 can help to resist further penetration of the spike 109 into the veneer. When mounted to a belt, e.g., belt 52, the spike can be oriented such that the width of the tip is substantially parallel to the grain and perpendicular to the veneer flow direction 72. Consequently, when veneer is impaled, penetrated, or otherwise contacted by the spike 109, the spike 109 can tend to separate fibers of the veneer without significantly cutting these fibers.

Although variable in dimension, the length of the spike 109 from the upper surface 454 of the shank 426 to the tip 432 can range from a low of about 0.5 cm, about 0.7 cm, about 1 cm, about 1.3 cm, or about 1.5 cm to a high of about 2.5 cm, about 2.7 cm, about 3 cm, about 3.3 cm, about 3.5 cm, about 3.7 cm, or about 4 cm. For example, the length of the spike from the upper surface 454 of the shank 426 to the tip 432 can be about 1.8 cm, about 1.9 cm, about 2 cm, about 2.1 cm, about 2.2 cm, about 2.3 cm, about 2.4 cm, about 2.5 cm, about 2.6 cm, about 2.7 cm, about 2.8 cm, or about 2.9 cm. In another example, the length of the spike from the upper surface 454 of the shank 426 to the tip 432 can range from about 2 cm to about 2.7 cm, about 2.5 cm to about 3 cm, about 1.4 cm to about 1.9 cm, about 2.1 cm to about 2.7 cm, or about 2.35 cm to about 2.45 cm.

The length of the spike 109 from the surface 422 to the upper surface 454 of the shank 426 can vary. The length of the spike 109 from the surface 422 to the upper surface 454 of the shank 426 can depend, at least in part, on the thickness of the belt, e.g., belt 52 through which the spike 109 can be disposed through an aperture defined therein. The length of the spike 109 from the surface 422 to the upper surface 454 of the shank 426 can range from a low of about 0.5 cm, about 0.6 cm, about 0.7 cm, about 0.8 cm, about 0.9 cm, or about 1 cm to a high of about 1.2 cm, about 1.4 cm, about 1.6 cm, or about 1.8 cm.

The spike 109 can have a diameter or average cross-sectional length as measured from opposing sides of the shank 426 ranging from a low of about 0.3 cm, about 0.4 cm, about 0.5 cm, or about 0.6 cm to a high of about 0.8 cm, about 0.9 cm, about 1 cm, or about 1.1 cm. For example, the diameter or average cross-sectional length of the shank 426 can range from about 0.6 cm to about 1 cm, or about 0.7 cm to about 0.9 cm, or about 0.75 cm to about 0.85 cm. In at least one example, the diameter or average cross-sectional length of the shank 426 can be about 0.63 cm (about 0.25 inches), about 0.79 cm (about 0.3125 inches), or about 0.95 cm (about 0.375 inches). The spike 109 can have a diameter or average cross-sectional length as measured from opposing sides of location 452 intermediate the location 440 and an upper surface 454 of the shank 426 can be less than the diameter or average cross-sectional length of the shank 426.

The spikes 109 can be made of any suitable material. Preferably the spikes 109 can be made from one or more rigid or semi-rigid materials. Suitable materials the spikes 109 can be made from can include, but are not limited to, one or more metals, metal alloys, non-metallic material, synthetic materials, non-synthetic materials, and combinations thereof. For example, the spike 109 can be or include a metal or metal alloy body, optionally, coated with one or more non-metallic materials. Other illustrative materials can include, but are not limited to, metallic materials (such as aluminum, steel, stainless steel, copper, nickel, cast iron, galvanized or non-galvanized metals, brass, etc.), fiberglass, and/or plastics (such as polyethylene, polypropylene, polystyrene, polyurethane, polyethylethylketone (PEEK), polytetrafluoroethylene (PTFE), polyamide resins (such as nylon 6 (N6), nylon 66 (N66)), polyester resins (such as polybutylene terephthalate (PBT), polyethylene terephthalate (PET), polyethylene isophthalate (PEI), PET/PEI copolymer) polynitrile resins (such as polyacrylonitrile (PAN), polymethacrylonitrile, acrylonitrile-styrene copolymers (AS), methacrylonitrile-styrene copolymers, methacrylonitrile-styrene-butadiene copolymers; and acrylonitrile-butadiene-styrene (ABS)), polymethacrylate resins (such as polymethyl methacrylate and polyethylacrylate), cellulose resins (such as cellulose acetate and cellulose acetate butyrate); polyimide resins (such as aromatic polyimides), polycarbonates (PC), elastomers (such as ethylene-propylene rubber (EPR), ethylene propylene-diene monomer rubber (EPDM), styrenic block copolymers (SBC), polyisobutylene (PIB), butyl rubber, neoprene rubber, halobutyl rubber and the like)), as well as mixtures, blends, and copolymers of any and all of the foregoing materials.

The spikes 109 can be machined, cast, forged, extruded, molded, or otherwise formed into a desired shape. For example, the spikes 109 can be a threaded bolt. The threaded bolt can be machined or otherwise shaped to provide the impaling portion 430 and tip 432. The impaling portion 430 of the spike 109 can be at least partially formed reducing a diameter of the bolt toward the end where the tip 432 will be located and further forming the tip or end 432 by further tapering or reducing the diameter of the bolt. The end of the bolt having the reduced diameter can then be pressed. By pressing the end, a rhombus or “diamond” shaped configuration can be formed into the end of the bolt to form the location 440 where the surfaces 436, 438 converge inwardly toward one another. The spikes 109 can be or include nails, tacks, screws, rods, pins, and the like.

FIG. 5 depicts an illustrative pinch belt assembly 40 with components in the embodiment of FIG. 5 being assigned in the same numbers as the components of FIG. 1. Since these components have been previously discussed, they will not be discussed further in connection with FIG. 5.

FIGS. 5A and 5B depict another illustrative embodiment of the pinch belt assembly 40. Again, components in common with the components of the pinch belt assembly 40 of FIG. 1 and of FIG. 5 have been assigned the same numbers and will not be discussed in detail. In the embodiments shown in FIGS. 5A and 5B, the support 130 can include a base support portion 460 with an upright wall section 462. The pinch belt assembly 40 can be carried by a pinch belt assembly support 464 pivotally connected to the wall section 462 by a pivot pin 468. In FIG. 5A, the pinch belt assembly can be pivoted from a first or operating position shown in FIG. 5A where the pinch belt 120 (as well as the pinch belts 120 of all the pinch belt assemblies 40) can be positioned by cylinders 138 in position to urge veneer against the spikes 109. If cylinders 138 are retracted, a greater gap exists between the pinch belt 120 (and the other pinch belts) and the spikes 109. When in this position material that may have jammed (e.g., multiple layers of veneer reaching the pinch belts assemblies simultaneously) can be cleared by the pinch belt 120 traveling in the direction of arrow 72 with the veneer being dropped onto the trash conveyor 270 (FIG. 2) as it will not be impaled by the spikes 109. The pinch belt assembly 40 of FIG. 5A can be pivoted about the axis of pivot pin 468 from an operating position shown in FIG. 5A to a clipper maintenance or clearance position shown in FIG. 5B to provide greater access to the clipper. Any suitable mechanism can be used for pivoting the pinch belt assembly 40 between the positions shown in FIGS. 5A and 5B. For example, a hydraulic or pneumatic cylinder 470 (a fluid cylinder) can have a rod portion 472 pivoted to the upright pinch belt support 134 and a cylinder housing pivoted to supporting framework, such as framework of the clipper as indicated schematically by component 474. Extension of the cylinder pivots the pinch belt assemblies from the position shown in FIG. 5A to the position shown in FIG. 5B, and vice versa. In FIGS. 5A and 5B, a pinch belt drive motor 476 is shown coupled by a chain 478 and respective drive gears 480, 482 to a pinch belt drive shaft 484 can be coupled to the respective pinch belts 120 for causing the pinch belts to travel in the direction of arrow 122.

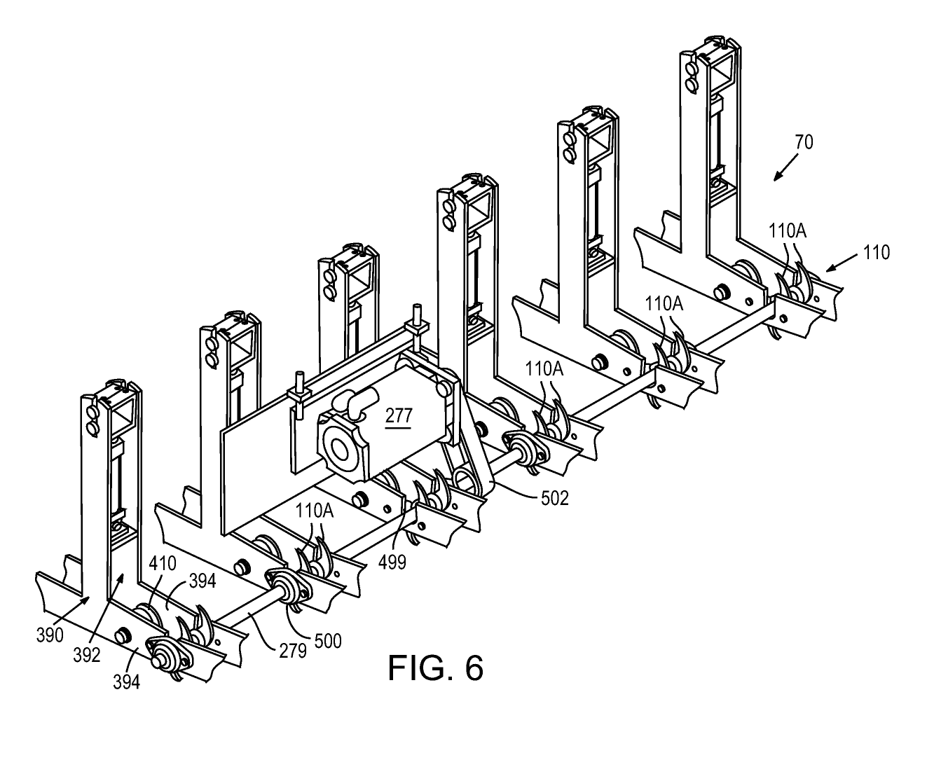

With reference to FIG. 6, a portion of the diverter body 70 is shown with the set of veneer engaging diverters 110 mounted to a diverter drive shaft 279. The drive shaft 279 can be coupled to a base portion 394 of the diverter assembly body 70 by bearings, such as bearing indicated by reference numeral 500. Components in FIG. 6 like those in figures previously discussed have been assigned the same numbers for convenience. Belt guiding pulleys (such as one numbered 410) are also shown in FIG. 6. In addition, in the structure shown in this figure, pairs of spaced apart veneer diverters 110A can be positioned between adjacent base components 394 with a gap provided therebetween within which an associated diverter belt can travel between the veneer diverters 110A. In FIG. 6, the drive motor 277 can, for example, be a stepper motor and can provide feedback to a drive motor controller. The motor 277 is shown coupled by a timing belt 502 to the shaft 279 for driving the shaft in rotation. Other mechanisms can be utilized to track the location of the diverters 110A, such as position sensors.

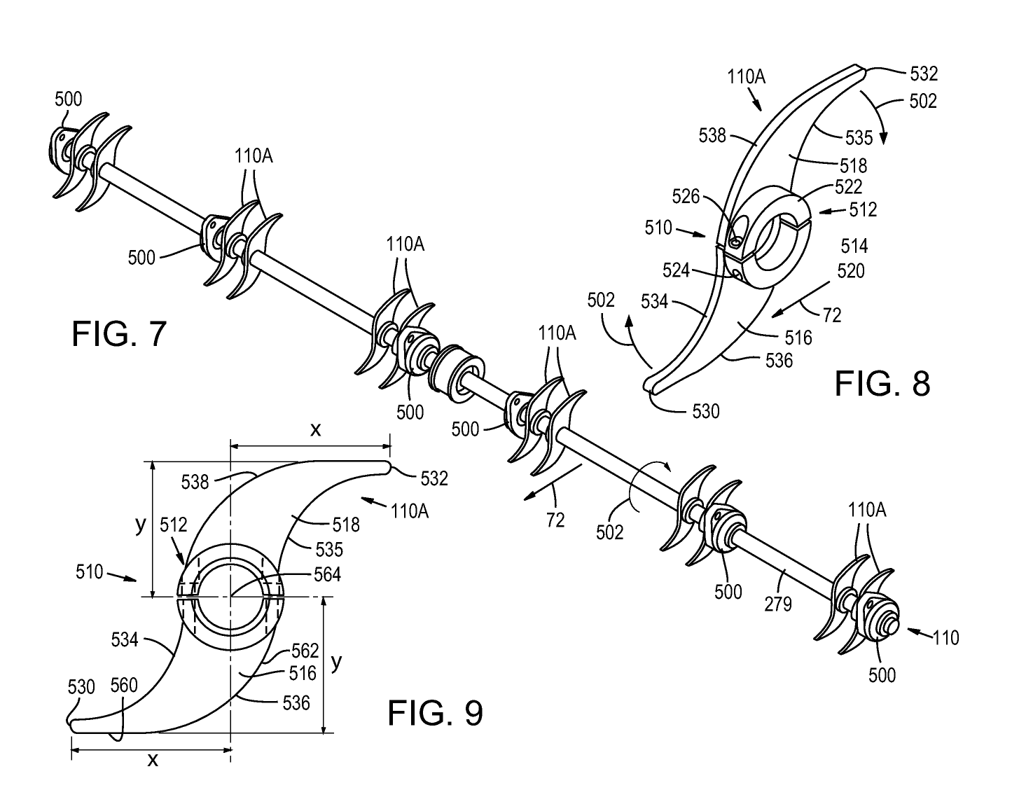

FIG. 7 depicts an illustrative a shaft 279 and a set of diverters 110 removed from the supporting structure shown in FIG. 6. As can be seen in FIG. 6, the shaft 279 can be received in slots that face upwardly in base 394 (one being numbered as 499 in FIG. 6) to permit removal of the shaft and diverters following disconnection of the bearings 500 from the base members 394. Referring again to FIG. 7, in use, the shaft 279 can be rotated in the direction of arrow 502.

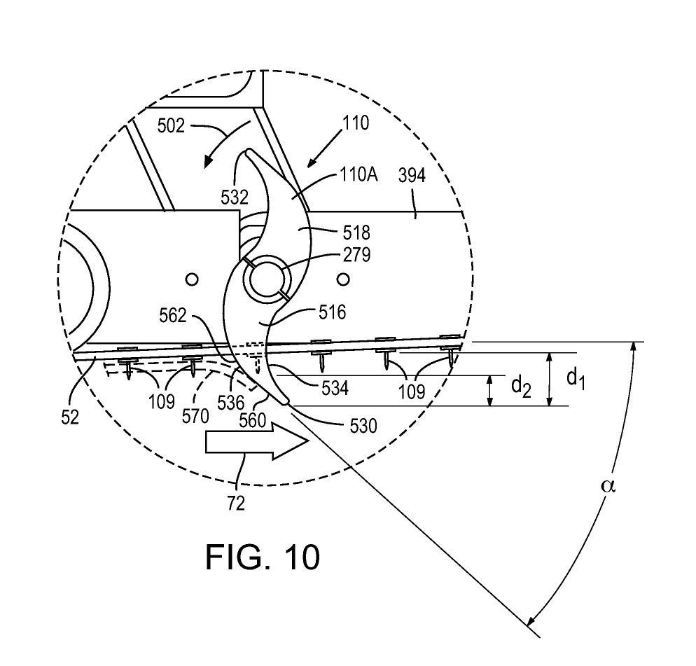

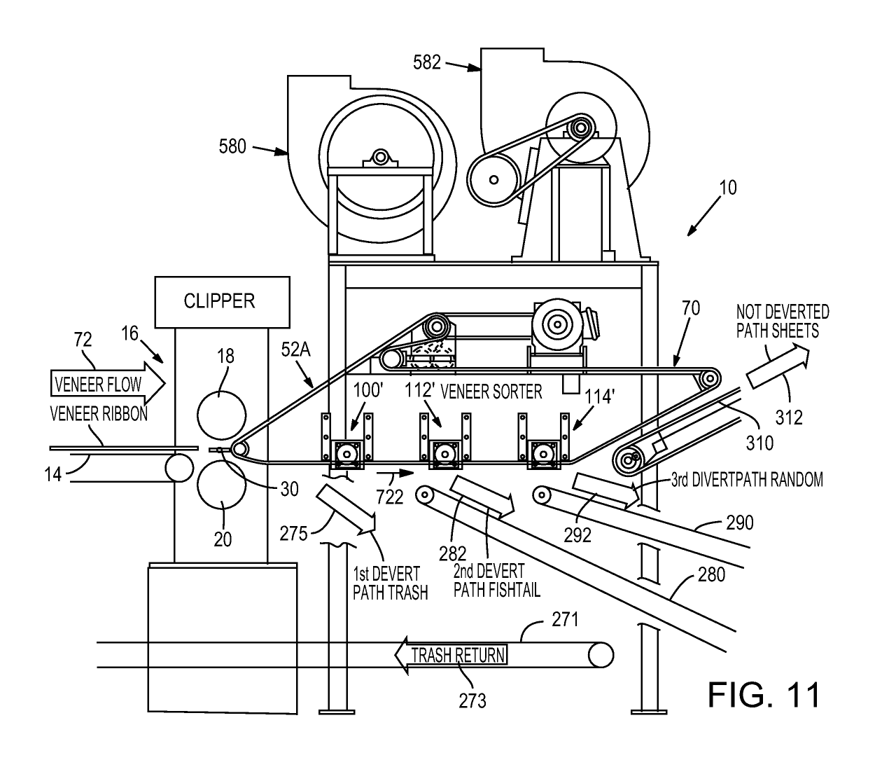

Although other forms of diverters can be used, a particularly advantageous form of diverter is illustrated in FIGS. 8 and 9. For convenience, the diverter in FIGS. 8 and 9 is labeled as 110A. It should be understood that, in the embodiment of FIGS. 8 and 9, adjacent pairs of diverters that straddle a belt can be mirror images of one another and thus the veneer diverter of FIG. 8 is a left hand diverter of the pairs shown in FIG. 7. The illustrated diverters 110A in FIGS. 8 and 9 can include a body portion 510. A shaft mount 512 can be included in, on, or otherwise about the body portion 510. The shaft mount 512 can define an opening 514 therethrough and extending through a central portion of the body portion 510 for receiving a support shaft, such as shaft 279 in FIG. 7. In one example, the diverter 110A can be formed of a plurality of sections, e.g., first and second sections 516, 518. A first portion 520 of mount 512 can be positioned at the proximal end portion (near the center of the assembled diverter 110A) of section 516. Another portion 522 of the mount 512 can be positioned at the proximal end portion of diverter section 518. The mount sections 520, 522 can each define a semicircular opening so that, when the mount sections are secured together, for example, by fasteners (not shown) extending through openings along the sides of the mount sections (e.g., see aligned openings 524, 526 in FIG. 9 with similar openings being provided at the opposite side of the mount sections). When fasteners are inserted into these openings (for example, threaded bolts) and tightened, the mount sections 520, 522 can clamp or otherwise secure the diverter 110A to the shaft 279. The diverter 110A and the shaft 279 can be made of durable material such as one or more metals or metal alloys. For example, the diverter 110A and/or the shaft 279 can be made of aluminum, steel, stainless steel, copper, nickel, cast iron, galvanized or non-galvanized metals, brass, etc. In at least one specific example, the diverter 110A and/or the shaft 279 can be made of steel, although a lighter weight durable material can be used (for example, the shaft can be made of aluminum). With this construction, the diverter 110A can readily be detached from the shaft 279 for replacement, for example if it becomes damaged.

Each of the diverter sections 516, 518 can include a respective distal end portion 530, 532 spaced from the proximal end portion mounted to the shaft 279. When rotated in the direction of arrow 502, the diverter sections 516, 518 each include respective first side edge portions 534, 535 that lead in the direction of rotation 502. In addition, each of the diverter sections 516, 518 can include another or second side edge surface 536, 538 that lag in the direction of rotation. As explained below, the surfaces 536, 538 can include veneer engaging surfaces that engage the veneer when the diverter 110A is in the lowered position (that is the respective surface 536 or 538 that is positioned in the veneer flow path) to divert the veneer away from the belts 52, 54, 56, 58, 60, and/or 62 and out of the veneer flow path. By providing two of the diverter sections 516, 518 per diverter, the shaft 279 need only be at most rotated 180 degrees to position another veneer diverter side edge 536 or 538 in position to divert veneer. In another example, the diverter 110A can be provided with only a single diverter section 516 or 518, although this would mean that the diverter section may have to be rotated through 360 degrees from the time it enters the veneer flow path to the time the diverter again enters the veneer flow path when rotated in the direction 502.

Since each of the surfaces 534, 535 can be the same in this embodiment and each of the surfaces 536, 538 can be the same in this embodiment, only the surfaces 534 and 536 will be described in detail. Thus, the illustrated veneer engaging surface 536 in one example can include a veneer engaging surface that does not lie entirely in a single plane. For example, the surface 536 can have at least a portion that is arcuate or curved in shape. In another example, the veneer engaging surface 538 can include a convex portion that is positioned to engage veneer traveling in a veneer flow path direction when the projecting portion of the diverter 110A is located, e.g., stopped in the veneer flow path. The surface 534 opposite to the veneer engaging surface 536 can include a concave portion.

Looking at the overall diverter 110A, in the form shown in FIGS. 7 and 8, the diverter can have a generally S-shaped diverter body shape with first and second diverter projections comprising the respective sections 516, 518 or those portions of these sections that extend into the veneer flow path. The width and dimensions of the S-shaped diverter body can be varied. In addition, the projecting portions of the sections 516, 518 extending away from a mounting shaft (for example, shaft 279) can include respective first and second cusp (or half crescent shaped) projections.

As further discussed and described below, when mounted to a diverter supporting shaft, such as shaft 279, in one example the diverter projections can be shaped and configured such that the angle of entry between the veneer engaging surface at the distal end portion of each diverter projection and the veneer flow path can be between about 75 degrees and about 105 degrees when the distal end portion rotates into the veneer flow path. The steep angle of entry can facilitate the positioning of a diverter projection between closely spaced veneer pieces. In one example, the angle of entry can be about 90 degrees. In another example, the angle of entry can range from a low of about 80 degrees, about 83 degrees, about 85 degrees, or about 87 degrees to a high of about 93 degrees, about 96 degrees, about 99 degrees, or about 102 degrees. By having a steep angle of entry and rotating the diverter in the direction of veneer flow, extremely fast veneer processing can be achieved. For example, the embodiment of FIG. 1, that can include the belts 52, 54, 56, 58, 60, and/or 62 and diverters 110A as shown in FIGS. 8 and 9, have been successfully operated at speeds of veneer travel (diverter belt speeds) of about 435 feet per minute.

With reference to FIG. 9, the veneer engaging surface 536 can include a straight portion 560 adjacent to the distal end 530 and a curved portion 562 extending from the straight portion, in this example, to a location adjacent to or at the proximal end of the section 516. Also, the sides 534, 536 can converge toward one another moving toward the distal end 530. This configuration of the distal end 530 can facilitate entry of the distal end 530 into the veneer flow path.

The dimensions of the diverter 110A can be varied. In one example, a height “y” measured from a line intersecting the center 564 of the diverter 110A and a line intersecting the straight edge 560 can be about 6.65 cm (about 2.62 inches). In another example, the height y can range from a low of about 4 cm, about 4.5 cm, about 5 cm, or about 5.5 cm to a high of about 7 cm, about 7.5 cm, about 8 cm, about 8.5 cm, or about 9 cm. In addition, a distance “x” from the center 564 of the diverter 110A along a line intersecting the plane of edge 560 to the distal end 530 can be about 7.85 cm (about 3.09 inches). In another example, the distance x can range from a low of about 4.5 cm, about 5 cm, about 5.5 cm, about or about 6 cm to a high of about 8 cm, about 8.5 cm, about 9 cm, about 9.5 cm, or about 10 cm. These particular dimensions (y and x) are for specific example of a diverter 110A and can be varied.

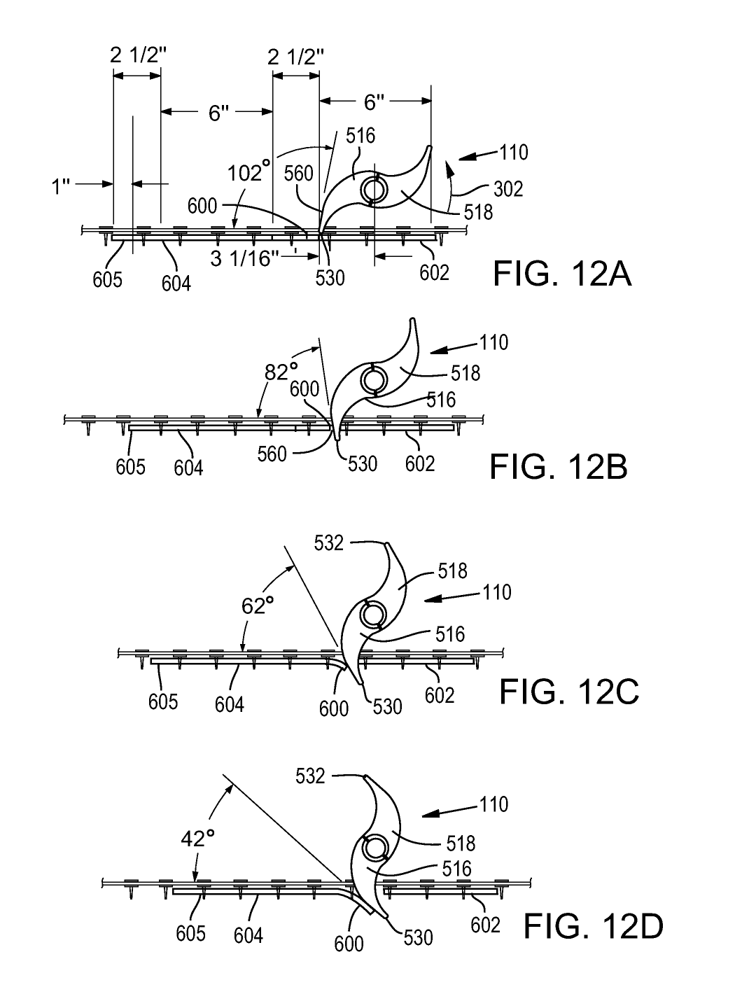

FIG. 10 illustrates one of the diverters 110A (which is a mirror image of the diverter shown in FIGS. 8 and 9) in position to divert a piece of veneer 570 impaled by spikes 109 downwardly and away from the belt 52. As the piece of veneer 570 approaches the location of diverter 110A, the diverter 110A can be moved in the direction of arrow 502 (by rotating the shaft 279) into the veneer flow path, as shown in FIG. 10. If, however, the diverter 110A is already positioned as shown in FIG. 10, the projecting portion of diverter section 516 simply remains in position for diverting veneer. As the belt 52 carries the veneer 570 in the direction of arrow 72, the leading edge of the veneer 570 can engage the veneer engaging surface 536 of the diverter 110A and can be directed downwardly along surface 560 and away from the belt 52. In this example, the angle between surface 560 and the belt 52 is indicated as α. The angle α can be about 45 degrees. The angle α can range from about 35 degrees to about 50 degrees, or from about 40 degrees to about 47 degrees, or from about 41 degrees to about 43 degrees. In at least one specific example, the angle α can be about 42 degrees. In the position shown, the distal end 530 can be positioned below an undersurface of the veneer 570 held by the belt 52. For example, a distance D1 from the undersurface of the belt at the location of the diverter 110A to the distal end of the diverter 110A can be, for example, about 4.13 cm (about 1⅝ inches). In another example, the distance D1 can range from about 2.5 cm, about 3 cm, or about 3.5 cm to a high of about 4 cm, about 5 cm, about 6 cm, about 7 cm, or about 8 cm. In addition, the distance D2 from the end 432 of a spike 109 at the location of the diverter 110A to the distal end 530 can be 2.54 cm (about 1 inch). In another example, the distance D2 can range from a low of about 1.4 cm, about 1.6 cm, about 1.8 cm, or about 2 cm to a high of about 2.6 cm, about 2.8 cm, about 3 cm, or about 3.2 cm. These particular dimensions are exemplary and can be varied. It is desirable, however, to have a portion of the diverter 110A extending below the level of the veneer 570 to direct the veneer in the desired direction as the veneer 570 disengages from the belt 52.

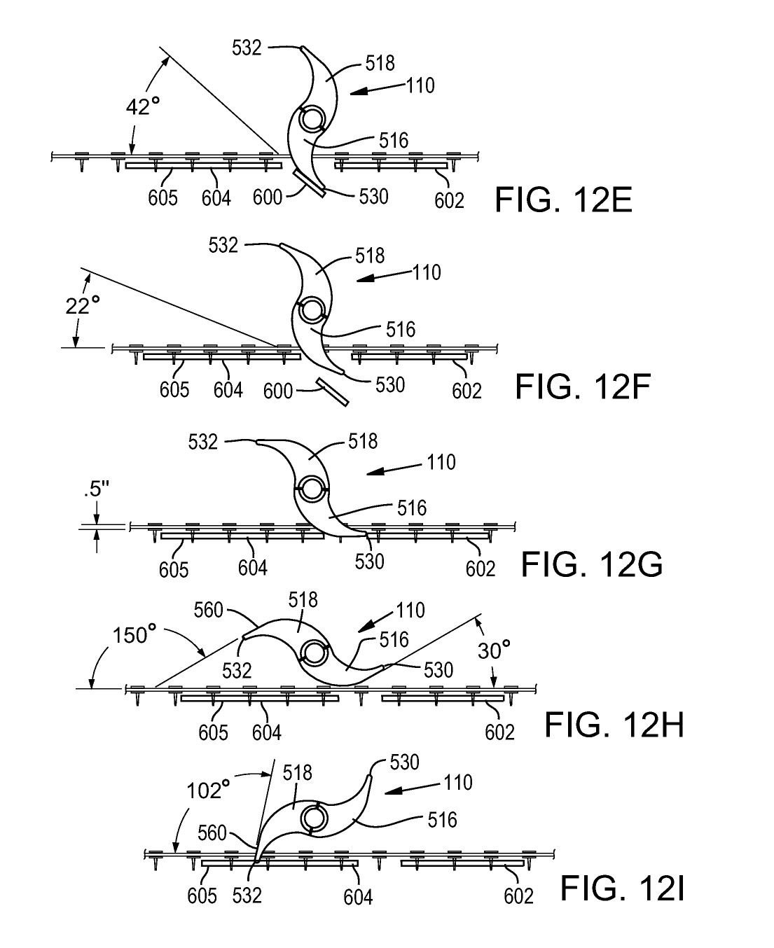

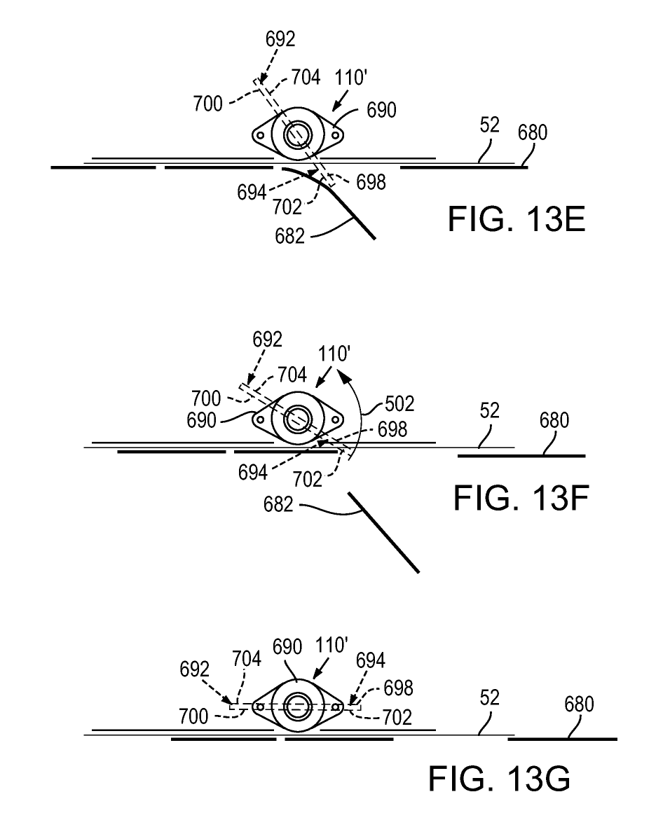

FIG. 11 depicts another illustrative wood handling system 10 in which the veneer can be engaged to the belt using a vacuum instead of spikes. For convenience, the same numbers have been used in FIG. 11 for components in FIG. 11 that are in common with those of FIG. 1, with these components not being discussed further. The sets of veneer diverters 110′, 112′, 114′ can be the same form of diverters as shown in FIG. 1 and in FIGS. 7-9. Alternatively, the diverters of the diverter sets can be of a different form, such as shown in FIGS. 13A-13G and explained below. The diverter assembly body 70 can be as shown in FIG. 11. Alternatively, the diverter assembly body can be of the form discussed previously in connection with FIGS. 1-3; or another suitable form. Also, the wood handling system 10 of FIG. 11 can be like that shown in FIG. 2 above. However, in the FIG. 11 embodiment of the wood handing system 10, only three sets of diverters are shown with only a single path and conveyor 310 for undiverted sheets, such as full sheets of veneer. In a vacuum system, desirably baffles can be positioned above the veneer diverters of the diverter sets 110′, 112′ and 114′ (the ′ designation indicates that different configurations of diverters can be used in the sets) to at least partially shield or isolate the diverters from the vacuum being drawn by vacuum blowers 580, 582 being used to apply a vacuum to draw the veneer toward the belts. The baffles can prevent or reduce the likelihood of the diverted veneer from being drawn back toward the belt prior to reaching the appropriate conveyor.

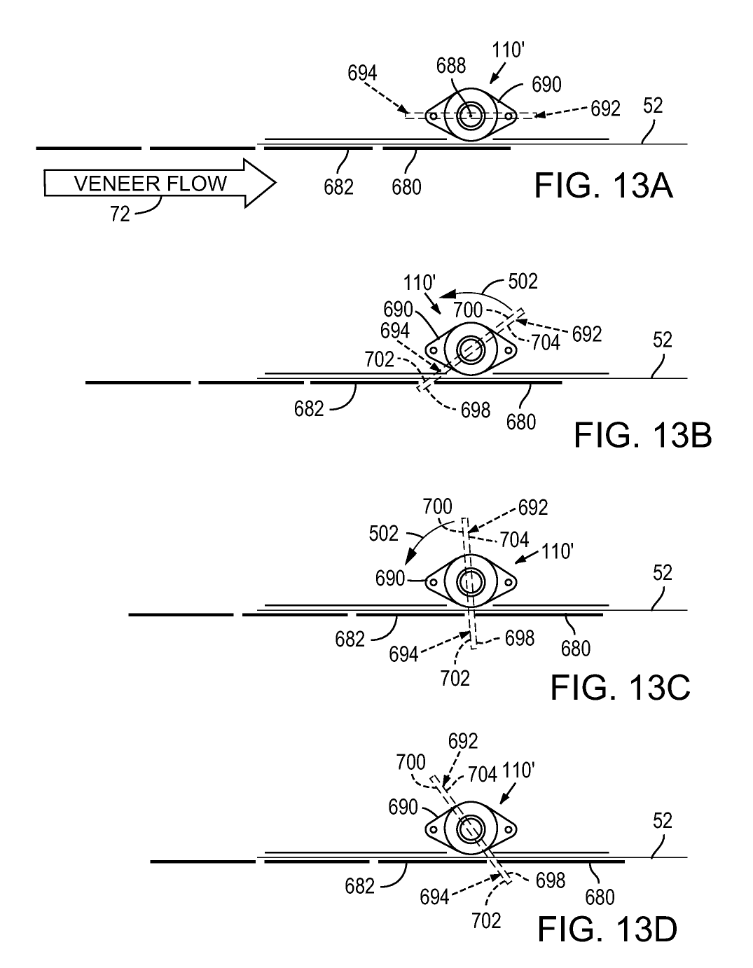

FIGS. 12A-12I illustrate a sequence where the set of diverters 110 can be operated to divert a small piece of trash veneer 600 (e.g., about a 6.35 cm or 2.5 inch wide piece of veneer) that follows a random piece of veneer 602 and can be followed by another random piece of veneer 604 and a piece of trash veneer 605 in the veneer flow path. In FIG. 12A, the leading edge of the trash veneer 600 has reached the location where the distal end 530 is entering the veneer flow stream. In this position, the distal end 530 of diverter 110 is in position to cross the veneer flow path as the diverter 110 is rotated in the direction of arrow 502. In FIG. 12A, the angle between the straight surface portion 560 of diverter section 516 and the upper surface of the belt is indicated at 102 degrees. The angles referenced below are also between the surface 560 and the upper surface of the belt with these angles changing as the veneer diverter is rotated. In FIG. 12B, the veneer diverter 110 has been rotated further so that the angle is now at 82 degrees and the dislodgement of the piece of veneer 600 from the belt has commenced. In FIG. 12C, the angle is now 62 degrees and further dislodgement of the trash veneer 600 has taken place. In FIG. 12D, the diverter 110 has been rotated to a stopping position where, in this example, the angle is 42 degrees. Again, further dislodgement of the piece 600 has taken place. In FIG. 12E, the angle has remained at 42 degrees with the piece 600 being directed by the diverter downwardly and away from the spikes and the belt. Since the downstream piece of veneer 604 following the trash piece 600 is another good random piece of veneer, the diverter 110 needs to be moved so as to not divert the piece 604 from the veneer flow path at the trash veneer diversion location. The diverter can be rotated such that the veneer engaging surface in the veneer flow path travels at the same speed as veneer through the veneer flow path. Thus, as can be seen if FIG. 12F, the diverter 110 has moved further with the distal end 530 traveling generally in the veneer flow direction and the angle now at 22 degrees. In FIG. 12G, the diverter has almost exited the veneer flow path. In FIG. 12H, the diverter has entirely left the diverter flow path and the angle between the surface 560 of the diverter section 518 and the belt is now at 150 degrees and the angle between the surface adjacent to the distal end 530 of diverter 516 and the belt is 30 degrees. The diverter can be held in this position as a random piece of veneer 604 passes the location of the diverter set 110. In this example, since the next piece of veneer 605 is another trash piece of veneer, as it approaches the diverter 110, the diverter is moved in FIG. 12I to the position shown in FIG. 12A to position the distal end 532 of the diverter in position to divert the trash piece of veneer 605. That is, the section 518 has been moved such that the angle between its surface 560 and the belt is now 102 degrees and the process repeats. If two successive pieces of veneer are trash veneer, the diverter 110 can be maintained in the position shown in FIGS. 12D and 12E until the successive pieces of trash veneer are diverted.

FIGS. 13-A-13G illustrate another form of diverter 110′ for moving veneer downwardly and away from belts such as belt 52. For purposes of discussion, assume the diverters shown in this figure are operated to divert trash veneer from the veneer flow stream and that a piece of random grade veneer 680 is held in engagement with belt 52 (and the other belts of the diverter not shown in these figures) followed by a piece of trash veneer 682. In FIG. 13A, the diverter set is labeled as 110′ even though only one diverter is actually visible in this figure. The diverter of FIG. 13A can include a plate 686 rotatable about an axis 688, for example, in the direction 502 as shown in FIG. 13B. The plate can be rotatably mounted at its edges by respective mounts, one of which is indicated at 690 in FIG. 13A. A first veneer diverting projection or section 692 of the veneer diverter can project or extend in one direction from center 688 and a second veneer diverting section 694 can project or extend in the opposite direction from center 688. The projection 692 can include a first planar surface 700 that leads in the direction of rotation and a second veneer engaging surface 704 that can also be planar and that lags in the direction of rotation. End section 694 can also include a first surface 698, that can be planar, that leads in the direction of rotation and a second veneer engaging surface 702, that is also shown as a planar surface and that lags in the direction of rotation. As the veneer piece 680 passes the diverters 110′ (see FIG. 13B), the diverter section 694 is rotated in position to intercept the trash veneer 682 to divert the trash veneer downwardly and away from the belt 52. As can be seen in FIG. 13B, the surface 702 is at an acute angle that is less than 45 degrees when the section 694 has been inserted between veneer pieces 680 and 682. With a planar shaped diverter as shown in FIG. 13B, it is more difficult to insert a diverter between veneer sheets especially as the speed of veneer travel along the belt increases. In testing, diverters of the form shown in FIGS. 13A-13G, the diverters were operated at slower conveyor speeds as compared to the conveyor speeds used with the diverters of the configuration shown in FIGS. 7-9. As continued rotation of the diverter occurs as shown in FIGS. 13C and 13D, the piece of veneer that is to be diverted away from the belt 52 has yet to be dislodged even though the diverter section 694 has passed a vertical position. When diverter 110′ reaches a position shown in FIG. 13D, its rotation is stopped and the veneer engaging diverting surface 702 is in position to divert the trash veneer 682 away from the belt 52 as shown in FIG. 13E. FIG. 13F shows the trash veneer 682 traveling downwardly away from the belt 52 toward, for example, a trash haulback conveyor. Assuming the next piece of veneer 710 is not trash veneer in this example, in FIG. 13F the diverter 110 is rotated to shift diverter projection 694 out of the veneer flow path as shown in FIG. 13G. FIG. 13G shows the diverter 110′ in the same position as shown in FIG. 13A except that the diverter section 692 is in a ready position to be rotated into the veneer flow path to intercept the next piece of trash veneer.

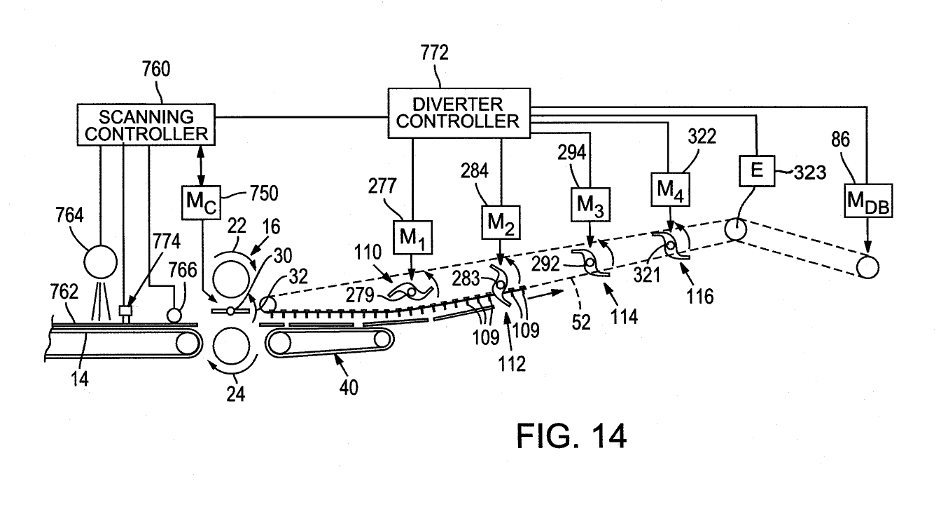

With reference to FIG. 14, an exemplary control system for a wood veneer handling system described above is shown. In the system of FIG. 14, components like those discussed in connection with FIGS. 1 and 11 have been assigned like numbers and therefore will not be discussed in detail. The system illustrated in FIG. 14 does have four sets of diverters 110, 112, 114 and 116. Respective motors 277, 284, 294 and 322 control the position of the diverters 110, 112, 114 and 116 (or 110′, 112′ and 114′ in FIG. 11) in response to motor control signals. In addition, a diverter drive belt motor 86 is shown coupled to the diverter belts (e.g., such as to belt 52 shown numbered in FIG. 14) to move these belts. Although a vacuum system can be used, belts including spikes 109 are shown in this particular example. It should be noted that the spikes 109 would impale the veneer and a vacuum would hold the veneer against the belts even though the veneer is shown spaced from the spikes in this example. In addition, a pinch belt mechanism 40 is shown for urging the veneer against the belts. The clipper 16 can include a clipper blade 30 operable by a clipper motor 750 to cause the blade to rotate and complete a veneer clip. The blade is operable in a conventional manner to clip the veneer in response to a veneer clipping signal from a scanning controller 760 delivered to the motor 750. The scanning controller generates the clipping control signals in response to signals from a scanner that examines the veneer for defects. One example of an exemplary scanner and scanning controller is a Ventek New Vision model scanner system that is commercially available. Upon completion of a clip, a signal is returned to the scanning controller so that the scanning controller can track the precise location along a ribbon of veneer 762 at which the clip was made. The scanning controller can include a processor that can be programmed as disclosed herein. The scanning controller 760 receives signals from a scanner 764 positioned to scan the ribbon of veneer 762 as it passes the scanner. The scanning controller determines the grade of veneer (full sheet, random, fishtail, trash, etc.) and provides diverter control output signals to control the rotation of the diverter shafts to sort the grades of the veneer. A position tracker, such as a roller 766 positioned to roll on the surface of the veneer ribbons 762 provides signals, for example pulses, to the scanning controller so that the scanning controller can track the position of the veneer that was scanned and the clipper for precisely controlling the veneer clips. Following the clipper, the veneer passes to a pinch belt mechanism 40 and is urged against the diverter belts including belt 52. The speed of the diverter belts and of the wood entering the clipper can be encoded and locked together so that the precise location of a clipped piece of a veneer on the belts is known. As the clipped veneer travels toward the plural sets of diverters 110, 112, 114 and 116, the scanning controller, because it knows the grade of the veneer of a particular clip from the scanning, provides diverter control signals to a diverter controller, which can be a PLC controller, that provides motor control signals in response to the diverter control signals from the scanner to control the various diverter motors in response to the diverter control signals. Diverter controller, for example, can control the belt motor 86 and can selectively control the respective diverter motors 277, 284, 294 and 322 to thereby control whether a particular piece of veneer is to be diverted downwardly away from the belts by a set of diverters. A shaft encoder 323 (labeled as E in FIG. 14) can be used to provide input to the diverter controller to enable the diverter controller and scanner controller to monitor the movement of the veneer carrying belts.

It should be noted that the pinch belt assembly 40 can be driven by a separate motor, for example, or by a clipper outfeed belt drive. The respective motors 277, 284, 294 and 322 can, for example, be servo motors coupled to the diverter controller 772 so that the diverter controller can precisely control the position of the respective veneer diverters of the sets 110, 112, 114 and 116. A sheet moisture detector can also be included as indicated at 774 for detecting the moisture content of the sheets to, for example, determine whether the wood is sapwood with a high moisture content. The scanner controller can send diverter control signals to the diverter controller for use in controlling the position of the veneer diverters 116 in the event sapwood is to be diverted from the belts by the diverter 116. This sapwood/non sapwood sort is simply one option as the diverters 116 can perform grade separation sorting or other full sheet sorting defined by the veneer mill.

A clipper scanner, such as a New Vision Scanner from Ventek, can provide, for example, 24 volt DC signals to selectively operate the diverters at the different divert points. The first divert point, corresponding to the position of veneer diverters 110, can be designated DV1 with divert points DV2 corresponding to a location of diverters 112, DV3 corresponding to location of diverters 114, and DV4 corresponding to location of diverters 116. Although other signals and configurations can be used, in one specific example, in response to a 24 volt DV1 signal from scanning controller 760, diverter controller 772 causes motor 277 to be energized to retract the diverters 278 to thereby pass fishtail, random veneer and full sheet veneer toward the other three divert points. In response to deenergization of the 24 volt divert control signal, the motor 277 is operated to rotate the veneer diverters into a position to divert or knock off trash pieces of veneer. The diverters can also be extended to their divert positions when there is no wood present. Wood that is diverted (knocked down) by the set of diverters 110 can fall onto a haulback conveyor and be transported to a chipper in the example of FIG. 1.

The second divert point DV2 has two modes of operation in this illustrative example. In mode 1, divert point DV2 is energized to retract the diverters 112 to allow random veneer and full sheet veneer to pass with the diverters 110 remaining retracted or out of the veneer flow stream as long as a 24 volt DC control signal is active (high). The divert point DV2 will be deenergized (the 24 volt DC signal output will be turned off) under conditions where there is no wood, trash or fishtail. Since trash wood is diverted by diverters 110, diverters 112 in effect separate fishtail from random and full sheet wood. As an alternative, divert point DV2 can be operated to only retract when full sheets are detected to allow the full sheets to pass. In this mode of operation, fishtail, trash and random veneer as well as no wood, will cause the DV2 signal to be turned off (deenergized) so that the diverters 112 are shifted to their divert position. In this case, any wood that reaches diverters 112, other than full sized sheets will be diverted. Since trash wood has been diverted by paddles 110, in this example fishtail and random veneer is separated by the diverters 112.

Divert point DV3 will be energized (the 24 volt output signal will be turned on to cause the diverters 114 to refract) at times when full sheets are reaching the divert point associated with the diverters 114. In this case, full sheets will pass the diverters 114. The DV3 signal is deenergized (turned off) under conditions of no wood, trash, fishtail and random veneer. In this case, the diverters 114 in essence divert random veneer from the belt as the diverters 110 have previously diverted trash veneer and the diverters 112 have previously diverted fishtail veneer.

The optional divert point DV4 associated with diverters 114, if provided, can be used to separate full sheets, for example, between two stackers. The sapwood signal from the scanner can be used as an input to the diverter controller 772 with the diverter controller controlling motor 322 based on the presence or absence of sapwood. The scanner controller can provide a pulsed signal output to the diverter controller for divert point DV3 that is energized (turned on) to indicate the leading edge of a full sheet. The pulsed output can stay on for an adjustable time, for example from about 10 milliseconds to about 100 milliseconds. With the knowledge of the fact that a leading edge of a full sheet has reached diverters 114, and assuming the wood is sapwood or has another characteristic that is being sorted (e.g., knot size and number), the diverters 116 can be shifted to a divert position in response to signals from the diverter controller to cause the shifting of the diverters 116 to a position to divert the sapwood away from the belt. If the full sheet is not sapwood or not of another desired sorting grade, the diverters 116 can be retracted with the full sheet being passed to a different location. Thus, in the above system, the scanning controller can control the operation of the diverter controller based on scanning by the scanner. This is proven to be an extremely effective control approach. Other control approaches can alternatively be used. It should also be noted that the motors 277, 284, 294 and 322 can be operated to separate wood veneer by different categories and in different orders. For example, random veneer can be diverted ahead of fishtail veneer. However, it is typically more effective to first remove the trash veneer followed by other grades of veneer with the best graded veneer being removed last.

Embodiments of the present disclosure further relate to any one or more of the following paragraphs:

1. An apparatus for transporting a wood veneer, comprising: a belt; and a plurality of spikes extending from a first side of the belt, wherein the plurality of spikes are configured to detachably engage with a wood veneer.

2. The apparatus according to paragraph 1, wherein each spike is disposed through an aperture defined by the belt.

3. The apparatus according to paragraph 1 or 2, wherein each spike comprises a base, a shank extending from the base, an impaling portion extending from the shank and terminating at an end.

4. The apparatus according to paragraph 3, wherein the shank comprises one or more threads disposed on an outer surface thereof, wherein the base is adjacent the second side of the belt and a nut is threadably engaged with at least a portion of the one or more threads about the first side of the belt such that the belt is located between the base and the nut.

5. The apparatus according to any on of paragraphs 1 to 4, wherein each spike extends from the first side of the belt a length ranging from about 0.5 cm to about 4 cm.

6. The apparatus according to any on of paragraphs 1 to 5, wherein the plurality of spikes are longitudinally disposed along a length of the belt, and wherein any two adjacent spikes are located a distance ranging from about 3.5 cm to about 6.5 cm from one another.

7. A system for transporting a wood veneer, comprising: a diverter body having one or more belts configured to move in a veneer flow direction, wherein each belt comprises: first and second opposing sides, wherein a first and second end of the belt are coupled to one another to provide a continuous belt; and a plurality of spikes extending from the first side thereof, wherein the plurality of spikes are configured to detachably engage with a wood veneer; and one or more veneer engaging diverters each rotatably coupled to the diverter body, wherein each veneer engaging diverter rotates in the veneer flow direction and comprises at least one projection extending therefrom and rotatable into and out of a veneer flow path, and wherein the projection engages a wood veneer traveling in the veneer flow direction when the projection is at least partially located in the veneer flow path.

8. The system according to paragraph 7, further comprising: a diverter controller; a veneer scanner at an upstream location along the veneer flow direction relative to the diverter body; and a veneer clipper between the veneer scanner and the diverter body, wherein the veneer flow path passes adjacent to the veneer scanner such that wood veneer is positioned for scanning by the veneer scanner.

9. The system according to paragraph 7 or 8, wherein the diverter body comprises two belts having a gap therebetween, and wherein at least one veneer engaging diverter is positioned with respect to the gap such that the projection is moveable within the gap between the two belts.

10. The system according to any one of paragraphs 7 to 9, wherein the projection comprises a veneer engaging surface that lies in more than one plane.

11. The system according to any one of paragraphs 7 to 10, wherein the one or more veneer engaging diverters are selectively operable such that the projection only engages the wood veneer when the wood veneer possesses one or more pre-determined properties.

12. A method for transporting a wood veneer, comprising: attaching a wood veneer to one or more spikes extending from a first side of one or more belts; and moving the one or more belts to transfer the wood veneer from a first location to a second location.

13. The method according to paragraph 12, wherein the one or more belts move in a veneer flow direction about a diverter body, the method further comprising: rotating one or more veneer engaging diverters in the veneer flow direction, wherein the one or more veneer engaging diverters have at least one projection extending therefrom, and wherein the at least one projection rotates into a veneer flow path; and contacting the wood veneer with the projection causing the wood veneer to detach from the one or more spikes.

14. The method according to paragraph 13, wherein the detached wood veneer is transferred to a conveyor.

15. The method according to paragraph 13, further comprising: attaching a plurality of wood veneers in sequence with respect to one another to the one or more spikes, wherein the one or more spikes are the same or different spikes for any two sequentially attached wood veneers, and wherein the one or more belts move in a veneer flow direction about a diverter body; rotating two or more veneer engaging diverters in the veneer flow direction, wherein each veneer engaging diverter has at least one projection extending therefrom, and wherein the at least one projection rotates into a veneer flow path; and contacting the plurality of wood veneers with one of the two projections of the at least two veneer engaging diverters to causing the wood veneer to detach from the one or more spikes; and transferring the detached wood veneer to a first conveyor, a second conveyor, or a combination thereof.

16. The method according to paragraph 15, wherein the plurality of veneers are selectively transferred to the first conveyor or the second conveyor in order to separate the plurality of wood veneers into two or more categories of wood veneer.

17. The method according to paragraph 13, wherein the detached wood veneer is deposited onto a surface.

18. The method according to paragraph 17, further comprising attaching a plurality of wood veneers in sequence with respect to one another to the one or more spikes, wherein the one or more spikes are the same or different spikes for any two sequentially attached wood veneers; and contacting the plurality of wood veneers with the projection in sequence with respect to one another to transfer the plurality of the wood veneers onto one another forming a stack of wood veneers.

19. A wood veneer handling system comprising: a frame; a diverter body coupled to the frame, the diverter body comprising top and bottom portions, first and second end portions and first and second side portions; a plurality of veneer transporting diverter belts coupled to a diverter body and supported for travel in a veneer flow direction along the bottom portion of the diverter body from the first end portion of the diverter body toward the second end portion of this diverter body, and operable to move pieces of veneer held in engagement with the belts along the bottom portion of the diverter body in a veneer flow path in the veneer flow direction with the travel of the belts, the belts being spaced apart transversely relative to the veneer flow direction; at least one set of plural spaced apart veneer engaging diverters, the one set of veneer engaging diverters being rotatably coupled to the diverter body for rotating about a first diverter axis that is transverse to the veneer flow direction, the first diverter axis being positioned above the veneer flow path, wherein each veneer engaging diverter comprises at least one diverter projection rotatable into, stoppable within, and rotatable out of the veneer flow path, the diverter projection rotating in the veneer flow direction in the veneer flow path, the diverter projection being operable such that, when the diverter projection is stopped in the veneer flow path and engages a piece of veneer traveling in the veneer flow direction, the diverter projection diverts the engaged piece of veneer from the belts and out of the veneer flow path; and wherein the diverter projection comprises a veneer engaging surface that does not lie entirely in a single plane.

20. The system according to paragraph 19, wherein there are plural veneer engaging diverters between each veneer transporting belt.

21. The system according to paragraph 19 or 20, the veneer engaging surface comprises a convex portion positioned to engage veneer traveling in the veneer flow direction when the diverter projection is stopped in the veneer flow.

22. The system according to paragraph 21, wherein the diverter projection comprises a second surface opposite to the veneer engaging surface, the second surface comprising a concave portion.

23. The system according to any one of paragraphs 19 to 22, wherein each diverter comprises at least two diverter projections with each diverter projection comprising a distal end portion and being configured such that the angle of entry between the veneer engaging surface at the distal end portion of each diverter projection and the veneer flow path is between 75 degrees and 105 degrees when the distal end portion rotates into the veneer flow path.

24. The system according to paragraph 22, wherein the angle of entry is approximately 90 degrees.

25. The system according to any one of paragraphs 19 to 24, wherein the diverters comprise a generally S-shaped diverter body comprising first and second diverter projections.

26. The system according to any one of paragraphs 19 to 25, wherein the diverters comprise first and second cusp projections.

27. The system according to any one of paragraphs 19 to 26, comprising at least first, second, and third diverter support shafts rotatably supported by the diverter body, the first diverter support shaft being rotatable about the first diverter axis, the second and third support shafts being supported by the diverter body for rotation about respective second and third diverter axes that are transverse to the veneer flow direction, the second and third diverter axes being positioned above the veneer flow path and being spaced apart from one another in the veneer flow direction, the at least one set of plural spaced apart veneer engaging diverters comprising a first set of plural spaced apart veneer diverters mounted to the first diverter support shaft for rotating about the first diverter axis, a second set of plural spaced apart veneer diverters mounted to the second diverter support shaft for rotating about the second diverter axis, and a third set of plural spaced apart veneer diverters mounted to the third shaft for rotating about the third diverter axis, the second set of veneer diverters being positioned downstream in the veneer flow direction from the first set of the veneer diverters, and the third set of veneer diverters being positioned downstream in the veneer flow direction from the second set of veneer diverters, a first diverter shaft motor coupled to the first diverter shaft and operable to selectively rotate the first diverter shaft to rotate the first set of veneer diverters in the veneer flow direction into and out of the veneer flow path, a second diverter shaft motor coupled to the second diverter shaft and operable to selectively rotate the second diverter shaft to rotate the second set of veneer diverters in the veneer flow direction into and out of the veneer flow path, and a third diverter shaft motor coupled to the third diverter shaft and operable to selectively rotate the third set of veneer diverters in the veneer flow direction into and out of the veneer flow path.

28. The system according to paragraph 27, comprising a diverter controller operable to provide diverter motor control signals, wherein the first, second and third diverter shaft motors are responsive to diverter motor control signals to rotate the respective first, second, and third sets of veneer diverters into and out of the veneer flow path, the apparatus comprising a veneer clipper operable to clip veneer into pieces in response to veneer clipping signals, a scanner operable to scan veneer to determine the grade of veneer, the scanner comprising a scanner controller operable to provide the veneer clip signals to clip pieces of veneer of various grades, including trash grade veneer, fishtail grade veneer, random grade veneer and fourth grade veneer, the scanner controller also being operable to provide diverter control signals to the diverter controller indicating the timing that the respective diverters are to be positioned in the veneer flow path to divert pieces of veneer from the veneer flow path in response to the diverter control signals, the diverter controller providing the diverter motor control signals to the diverter motors so as to control the diverters to divert and sort the different categories of veneer; wherein as a piece of veneer that is of a better than trash grade veneer is reaching the first set of diverters, the first set of diverters are rotated by the first diverter motor out of the veneer flow path if not already out of the veneer flow path, and wherein the first set of diverters remain out of the veneer flow path until such time as the piece of veneer reaching the first set of diverters is no longer better than trash grade and the first set of diverters are rotated by the first diverter motor into the veneer flow path, or retained in the veneer flow path if already in the veneer flow path, such that the first set of diverters are operable to divert veneer that is no longer better than trash grade veneer downwardly from the diverter belts and away from the veneer flow path; wherein as a piece of veneer that is of a better than fishtail grade veneer is reaching the second set of diverters, the second set of diverters are rotated by the second diverter motor out of the veneer flow path if not already out of the veneer flow path, wherein the second set of diverters remain out of the veneer flow path until such time as a piece of veneer reaching the second set of diverters is no longer better than fishtail grade veneer and the second set of diverters are rotated by the second diverter motor into the veneer flow path, or retained in the veneer flow path if already in the veneer flow path, such that the second set of diverters are operable to divert veneer that is no longer better than fishtail grade veneer downwardly from the diverter belts and away from the veneer flow path; wherein as a piece of veneer that is of a better than random grade veneer is reaching the third set of diverters, the third set of diverters are rotated by the third diverter motor out of the veneer flow path if not already out of the veneer flow path, wherein the third set of diverters remain out of the veneer flow path until such time as the piece of veneer reaching the third set of diverters is no longer better than random grade veneer and the third set of diverters are rotated by the third diverter motor into the veneer flow path, or retained in the veneer flow path if already in the veneer flow path, such that the third set of diverters are operable to divert veneer that is no longer better than random grade veneer downwardly from the diverter belts and away from the veneer flow path; wherein as a full sized veneer sheet that is better than trash grade veneer, better than fishtail grade veneer and better than random grade veneer reaches the first, second and third sets of diverters, such diverters are not positioned in the veneer flow path so as to permit said full sized veneer sheet to pass the respective first, second and third sets of diverters.

29. The system according to paragraph 28, wherein there is at least one material conveyer associated with each set of diverters and positioned to receive material diverted from the veneer flow path by the associated diverters.

30. The system according to paragraph 27, comprising a diverter controller operable to provide diverter motor control signals, wherein the first, second and third diverter shaft motors are responsive to diverter motor control signals to rotate the respective first, second, and third sets of veneer diverters into and out of the veneer flow path, the apparatus comprising a veneer clipper operable to clip veneer into pieces in response to veneer clipping signals, a scanner operable to scan veneer to determine the grade of veneer, the scanner comprising a scanner controller operable to provide the veneer clip signals to clip pieces of veneer of various grades, including first grade veneer, second grade veneer, third grade veneer and fourth grade veneer, the scanner controller also being operable to provide diverter control signals to the diverter controller indicating the timing that the respective diverters are to be positioned in the veneer flow path to divert pieces of veneer from the veneer flow path in response to the diverter control signals, the diverter controller providing the diverter motor control signals to the diverter motors so as to control the diverters to divert and sort the different categories of veneer; wherein as a piece of veneer that is of a better than first grade veneer is reaching the first set of diverters, the first set of diverters are rotated by the first diverter motor out of the veneer flow path if not already out of the veneer flow path, and wherein the first set of diverters remain out of the veneer flow path until such time as the piece of veneer reaching the first set of diverters is no longer better than first grade veneer and the first set of diverters are rotated by the first diverter motor into the veneer flow path, or retained in the veneer flow path if already in the veneer flow path, such that the first set of diverters are operable to divert veneer that is no longer better than first grade veneer downwardly from the diverter belts and away from the veneer flow path; wherein of veneer that is of a better than second grade veneer is reaching the second set of diverters, the second set of diverters are rotated by the second diverter motor out of the veneer flow path if not already out of the veneer flow path, wherein the second set of diverters remain out of the veneer flow path until such time as a piece of veneer reaching the second set of diverters is no longer better than second grade veneer and the second set of diverters are rotated by the second diverter motor into the veneer flow path, or retained in the veneer flow path if already in the veneer flow path, such that the second set of diverters are operable to divert veneer that is no longer better than second grade veneer downwardly from the diverter belts and away from the veneer flow path; wherein as a piece of veneer that is of a better than third grade veneer is reaching the third set of diverters, the third set of diverters are rotated by the third diverter motor out of the veneer flow path if not already out of the veneer flow path; wherein the third set of diverters remain out of the veneer flow path until such time as the piece of veneer reaching the third set of diverters is no longer better than third grade and the third set of diverters are rotated by the third diverter motor into the veneer flow path, or retained in the veneer flow path if already in the veneer flow path, such that the third set of diverters are operable to divert veneer that is no longer better than third grade veneer downwardly from the diverter belts and away from the veneer flow path; wherein as a better grade piece of veneer that is better than first grade veneer, better than second grade veneer and better than third grade veneer reaches the first, second and third sets of diverters, such diverters are not in the veneer flow path so as to permit said better grade piece of veneer to pass the respective first, second and third sets of diverters.

31. The system according to paragraph 27, comprising a veneer scanner at an upstream location relative to the veneer flow direction from the diverter body and a veneer clipper intermediate to the veneer scanner and diverter body, the veneer flow path passing adjacent to the scanner such that veneer is positioned for scanning by the scanner, the scanner comprising a scanner controller coupled to and operable to control cutting of veneer by the clipper and operable to receive signals from the clipper indicating the location of clipping of the veneer, the scanner controller also providing diverter control signals for controlling the timing of operation of the various sets of diverters to sort the categories of veneer, a diverter controller coupled to the scanner controller, the diverter controller also being coupled to the first, second and third diverter motors to control the diverter motor to control the movement of the veneer diverters, a belt mover controlled by the diverter controller and operable to move the belts such that the belts travel in the first veneer flow direction along the bottom portion of the diverter body in response to operation of the belt mover, belt speed information being communicated to the scanner controller such that the scanner controller is operable to track the position of the leading edge of the veneer clipped by the clipper along the veneer flow path, the scanner controller sending diverter control signals to the diverter controller indicating the timing at which the respective sets of diverters are to be rotated into the veneer flow path by the diverter controller in response to the diverter control signals to sort the veneer, the diverter controller, responsive to the diverter control signals, sending diverter motor control signals to cause the movement of the respective sets of veneer diverters into and out of the veneer flow path.

32. An apparatus according to paragraph 27, wherein there is at least one additional diverter support shaft rotatably coupled to the diverter body for rotating about an additional transverse diverter shaft axis and at least one additional set of plural spaced apart veneer diverters mounted to said one additional diverter support shaft, and an additional diverter motor coupled to said additional diverter support shaft for rotating said additional set of plural spaced apart veneer diverters into and out of the veneer flow path in response to veneer category control signals.

33. The system according to any one of paragraphs 19 to 32, wherein the bottom portion of the diverter body is of a concave arcuate shape such that the veneer flow path curves upwardly in a direction from the first to the second end portions of the diverter body.

34. The system according to any one of paragraphs 19 to 33, comprising a pinch belt assembly at the first end portion of the diverter body and comprising plural pinch belts operable to urge veneer against the belts at least when the pinch belt assembly is in a first position, the pinch belt assembly being pivotally supported for pivoting movement between an operational position and at least one clearance position wherein the pinch belts are spaced further from the clipper than when the pinch belt assembly is in the operational position.

35. The system according to any one of paragraphs 19 to 34, comprising first and second sets of suspension supports extending upwardly from the top portion of the diverter body, a first set of suspension supports being positioned nearer to the first end portion of the diverter body than the second end portion of the diverter body and the second set of suspension supports being positioned nearer to the second end portion of the body than the first end portion of the diverter body, each of the suspension supports comprising a distal end portion spaced from the diverter body and a roller coupled to the distal end portion of the suspension support, the frame comprising a plurality of ramps, each ramp being associated with one of the rollers and comprising an upwardly inclined surface angled upwardly and away from the first end portion of the diverter body for rollingly receiving a respective associated one of the rollers, at least one actuator mounted to the frame and coupled to the diverter such that operation of the actuator in a first mode of operation moves each of the rollers along the associated ramp to thereby move each of the rollers upwardly along the ramps and such that operation of the actuator in a second mode of operation moves each of the rollers downwardly along the ramps, one or more catches pivotally mounted to the frame and positioned so as to pivot toward and away from an associated ramp, each catch comprising a plurality of downwardly facing teeth and being shaped and positioned such that as a roller moves upwardly along the ramp associated with the at least one catch, the teeth are coupled to the roller to prevent the roller from moving downwardly until such time as the catch is pivoted to a release position away from the ramp.

36. A wood veneer handling system comprising: a frame; a diverter body coupled to the frame, the diverter body comprising top and bottom portions, first and second end portions and first and second side portions; a plurality of veneer transporting diverter belts coupled to a diverter body and supported for travel in a veneer flow direction along the bottom portion of the diverter body from the first end portion of the diverter body toward the second end portion of this diverter body, and operable to move pieces of veneer held in engagement with the belts along the bottom portion of the diverter body in a veneer flow path in the veneer flow direction with the travel of the belts, the belts being spaced apart transversely relative to the veneer flow direction; at least one set of plural spaced apart veneer engaging diverters, the one set of veneer engaging diverters being rotatably coupled to the diverter body for rotating about a first diverter axis that is transverse to the veneer flow direction, the first diverter axis being positioned above the veneer flow path, wherein each veneer engaging diverter comprises at least one diverter projection rotatable into, stoppable within, and rotatable out of the veneer flow path, the diverter projection rotating in the veneer flow direction in the veneer flow path, the diverter projection being operable such that, when the diverter projection is stopped in the veneer flow path and engages a piece of veneer traveling in the veneer flow direction, the diverter projection diverts the engaged piece of veneer from the belts and out of the veneer flow path; at least first, second, and third diverter support shafts rotatably supported by the diverter body, the first diverter support shaft being rotatable about the first diverter axis, the second and third support shafts being supported by the diverter body for rotation about respective second and third diverter axes that are transverse to the veneer flow direction, the second and third diverter axes being positioned above the veneer flow path and being spaced apart from one another in the veneer flow direction, the at least one set of plural spaced apart veneer engaging diverters comprising a first set of plural spaced apart veneer diverters mounted to the first diverter support shaft for rotating about the first diverter axis, a second set of plural spaced apart veneer diverters mounted to the second diverter support shaft for rotating about the second diverter axis, and a third set of plural spaced apart veneer diverters mounted to the third shaft for rotating about the third diverter axis, the second set of veneer diverters being positioned downstream in the veneer flow direction from the first set of the veneer diverters, and the third set of veneer diverters being positioned downstream in the veneer flow direction from the second set of veneer diverters, a first diverter shaft motor coupled to the first diverter shaft and operable to selectively rotate the first diverter shaft to rotate the first set of veneer diverters in the veneer flow direction into and out of the veneer flow path, a second diverter shaft motor coupled to the second diverter shaft and operable to selectively rotate the second diverter shaft to rotate the second set of veneer diverters in the veneer flow direction into and out of the veneer flow path, and a third diverter shaft motor coupled to the third diverter shaft and operable to selectively rotate the third set of veneer diverters in the veneer flow direction into and out of the veneer flow path; a diverter controller operable to provide diverter motor control signals, wherein the first, second and third diverter shaft motors are responsive to diverter motor control signals to rotate the respective first, second, and third sets of veneer diverters into and out of the veneer flow path, the apparatus comprising a veneer clipper operable to clip veneer into pieces in response to veneer clipping signals, a scanner operable to scan veneer to determine the grade of veneer, the scanner comprising a scanner controller operable to provide the veneer clip signals to clip pieces of veneer of various grades, including trash grade veneer, fishtail grade veneer, random grade veneer and fourth grade veneer, the scanner controller also being operable to provide diverter control signals to the diverter controller indicating the timing that the respective diverters are to be positioned in the veneer flow path to divert pieces of veneer from the veneer flow path in response to the diverter control signals, the diverter controller providing the diverter motor control signals to the diverter motors so as to control the diverters to divert and sort the different categories of veneer; wherein as a piece of veneer that is of a better than trash grade veneer is reaching the first set of diverters, the first set of diverters are rotated by the first diverter motor out of the veneer flow path if not already out of the veneer flow path and wherein the first set of diverters remain out of the veneer flow path until such time as a piece of veneer reaching the first set of diverters is no longer better than trash grade veneer and the first set of diverters are rotated by the first diverter motor into the veneer flow path, or retained in the veneer flow path if already in the veneer flow path, such that the first set of diverters are operable to divert veneer that is no longer better than trash grade veneer downwardly from the diverter belts and away from the veneer flow path; wherein as a piece of veneer that is of a better than fishtail grade veneer is reaching the second set of diverters, the second set of diverters are rotated by the second diverter motor out of the veneer flow path if not already out of the veneer flow path; wherein the second set of diverters remain out of the veneer flow path until such time as a piece of veneer reaching the second set of diverters is no longer better than fishtail grade veneer and the second set of diverters are rotated by the second diverter motor into the veneer flow path, or retained in the veneer flow path if already in the veneer flow path, such that the second set of diverters are operable to divert veneer that is no longer better than fishtail grade veneer downwardly from the diverter belts and away from the veneer flow path; wherein as a piece of veneer that is of a better than random grade veneer is reaching the third set of diverters, the third set of diverters are rotated by the third diverter motor out of the veneer flow path if not already out of the veneer flow path; wherein the third set of diverters remain out of the veneer flow path until such time as the piece of veneer reaching the third set of diverters is no longer better than random grade veneer and the third set of diverters are rotated by the third diverter motor into the veneer flow path, or retained in the veneer flow path if already in the veneer flow path, such that the third set of diverters are operable to divert veneer that is no longer better than random grade veneer downwardly from the diverter belts and away from the veneer flow path; wherein as a full sized veneer sheet that is better than trash grade veneer, better than fishtail grade veneer and better than random grade veneer reaches the first, second and third sets of diverters, such diverters are moved out of or retained out of the veneer flow path so as to permit said full sized veneer sheet to pass the respective first, second and third sets of diverters; a veneer scanner at an upstream location relative to the veneer flow direction from the diverter body and a veneer clipper intermediate to the veneer scanner and diverter body, the veneer flow path passing adjacent to the scanner such that veneer is positioned for scanning by the scanner, the scanner comprising a scanner controller coupled to and operable to control cutting of veneer by the clipper and operable to receive signals from the clipper indicating the location of the leading edge of the clipped veneer, the scanner controller also providing the diverter control signals for controlling the timing of operation of the various sets of diverters to sort the categories of veneer, a diverter controller coupled to the scanner controller, the diverter controller also being coupled to the first, second and third diverter motors to control the diverter motor to control the movement of the veneer diverters, a belt mover controlled by the diverter controller and operable to move the belts such that the belts travel in the first veneer flow direction along the bottom portion of the diverter body in response to operation of the belt mover, belt speed information being communicated to the scanner controller such that the scanner controller is operable to track the position of the leading edge of the veneer clipped by the clipper along the veneer flow path, the scanner controller sending diverter control signals to the diverter controller indicating the timing at which the respective sets of diverters are to be rotated into the veneer flow path by the diverter controller in response to the diverter control signals to sort the veneer, the diverter controller, responsive to the diverter control signals, sending diverter motor control signals to cause the movement of the respective sets of veneer diverters into and out of the veneer flow path.

37. In a veneer handling apparatus, at least one veneer engaging diverter supported for diverting veneer downwardly from a veneer flow path, the veneer engaging diverter comprising an engager body portion having a central portion and first and second projecting end portions extending away from the central portion, the central portion comprising a shaft mount for coupling the veneer engager body portion to a rotatable shaft, the first projecting end portion comprising a first side edge that leads in the direction of rotation and a second side edge that lags in the direction of rotation upon rotation of the rotatable shaft in one direction, the second projecting portion comprising a first side edge that leads in the direction of rotation and a second side edge that lags in the direction of rotation upon rotation of the rotatable shaft in said one direction, and wherein each of the second side edges comprises a curved surface portion.

38. The apparatus according to paragraph 37, wherein the curved surface portion of each of the second such edges comprises a convex surface portion.

39. The apparatus according to paragraph 38, wherein the first side edges each comprise a concave surface portion.

40. The apparatus according to any one of paragraphs 37 to 39, wherein the veneer engager is generally S-shaped.

41. The apparatus according to any one of paragraphs 37 to 40, wherein the first and second projecting end portions each comprise a distal end and wherein the second side edges each include a straight edge portion adjacent to the distal end.

42. The apparatus according to paragraph 41, wherein the veneer engager is bifurcated through the central portion of the veneer engager body into first and second body sections, a portion of a first shaft receiving mount being positioned on the first body section and a portion of a second shaft receiving mount being positioned on the second body section.

43. The apparatus according to paragraph 42, wherein the first and second distal end portions are acute.

44. The apparatus according to any one of paragraphs 37 to 43, in combination with a shaft and comprising a plurality of said veneer engaging diverters coupled to the shaft, the diverters being aligned with one another along the shaft.

45. In a veneer handling apparatus, at least one veneer engaging diverter for diverting veneer from a veneer flow path, the veneer engaging diverter comprising an engager body portion having a central portion and first and second projecting end portions extending away from the central portion, the central portion comprising a shaft mount for coupling the veneer engager body portion to a rotatable shaft, the first projecting end portion comprising a first side edge that leads in the direction of rotation and a second side edge that lags in the direction of rotation upon rotation of the rotatable shaft in one direction, the second projecting portion comprising a first side edge that leads in the direction of rotation and a second side edge that lags in the direction of rotation upon rotation of the rotatable shaft in said one direction, and wherein each of the first and second projecting end portions comprises a distal end portion configured to intersect a veneer flow path at an angle of between 75 degrees and 105 degrees when the distal end portion is rotated into the veneer flow path.

46. The apparatus according to paragraph 45, wherein the angle of entry is approximately 90 degrees.

47. The apparatus according to paragraph 45 or 46, wherein the diverters comprise a generally S-shaped diverter body comprising first and second diverter projections.

48. The apparatus according to any one of paragraphs 45 to 47, wherein each of the second side edges comprises a convex surface portion and each of the first side edges comprises a concave surface portion, and wherein each of the second side edges includes a straight edge portion adjacent to the distal end.

49. In a veneer handling apparatus, at least one veneer engaging diverter for diverting veneer from a veneer flow path, the veneer engaging diverter comprising an engager body portion having a central portion and first and second projecting end portions extending away from the central portion, the central portion comprising a shaft mount for coupling the veneer engager body portion to a rotatable shaft, the first projecting end portion comprising a first side edge that leads in the direction of rotation and a second side edge that lags in the direction of rotation upon rotation of the rotatable shaft in one direction, the second projecting portion comprising a first side edge that leads in the direction of rotation and a second side edge that lags in the direction of rotation upon rotation of the rotatable shaft in said one direction, and wherein each of the second side edges comprises a curved surface portion, wherein the diverters comprise a generally S-shaped diverter body comprising first and second diverter projections.

50. A wood veneer handling system comprising: a frame; a diverter body coupled to the frame, the diverter body comprising top and bottom portions, first and second end portions and first and second side portions; a plurality of veneer transporting diverter belts coupled to a diverter body and supported for travel in a veneer flow direction along the bottom portion of the diverter body from the first end portion of the diverter body toward the second end portion of this diverter body and operable to move pieces of veneer held in engagement with the belts along the bottom portion of the diverter body in a veneer flow path in the veneer flow direction with the travel of the belts, the belts being spaced apart transversely relative to the veneer flow direction; at least first, second, third and fourth diverter support shafts rotatably supported by the diverter body for rotation about respective first, second, third and fourth diverter axes that are transverse to the veneer flow direction, that are positioned above the veneer flow path and that are spaced apart from one another in the veneer flow direction; a first set of plural spaced apart veneer engaging diverters mounted to the first diverter support shaft, the first set of veneer engaging diverters being rotatably coupled by the first diverter support shaft to the diverter body for rotating about the first diverter axis, each veneer engaging diverter comprises at least one diverter projection rotatable into, stoppable within, and rotatable out of the veneer flow path, the diverter projection rotating in the veneer flow direction in the veneer flow path, the diverter projection being operable such that, when the diverter projection is stopped in the veneer flow path and engages a piece of veneer traveling in the veneer flow direction, the diverter projection diverts the engaged piece of veneer from the belts and out of the veneer flow path, a second set of said plural spaced apart veneer engaging diverters mounted to the second diverter support shaft for rotating about the second diverter axis, and a third set of said plural spaced apart veneer engaging diverters mounted to the third shaft for rotating about the third diverter axis, the second set of veneer engaging diverters being positioned downstream in the veneer flow direction from the first set of the veneer diverters, and the third set of veneer engaging diverters being positioned downstream in the veneer flow direction from the second set of veneer engaging diverters, a fourth set of said plural spaced apart veneer engaging diverters mounted to the fourth diverter support shaft for rotating about the fourth diverter axis, the fourth set of veneer engaging diverters being positioned downstream in the veneer flow direction from the third set of veneer engaging diverters, and a fourth diverter shaft motor coupled to the fourth diverter shaft and operable to selectively rotate the fourth set of veneer engaging diverters in the veneer flow direction into and out of the veneer flow path; a first diverter shaft motor coupled to the first diverter shaft and operable to selectively rotate the first diverter shaft to rotate the first set of veneer engaging diverters in the veneer flow direction into and out of the veneer flow path, a second diverter shaft motor coupled to the second diverter shaft and operable to selectively rotate the second diverter shaft to rotate the second set of veneer engaging diverters in the veneer flow direction into and out of the veneer flow path, a third diverter shaft motor coupled to the third diverter shaft and operable to selectively rotate the third set of veneer engaging diverters in the veneer flow direction into and out of the veneer flow path; and a fourth diverter shaft motor coupled to the fourth diverter shaft and operable to selectively rotate the fourth set of veneer engaging diverters in the veneer flow direction into and out of the veneer flow path; wherein each of the veneer engaging diverters comprises plural diverter projections that each comprise a veneer engaging surface that does not lie entirely in a single plane, the veneer engaging surface being rotated into and out of the veneer flow path to divert veneer from the veneer flow path; a diverter controller operable to provide diverter motor control signals, wherein the first, second and third diverter shaft motors are responsive to diverter motor control signals to rotate the respective first, second, and third sets of veneer diverters into and out of the veneer flow path, the apparatus comprising a veneer clipper operable to clip veneer into pieces in response to veneer clipping signals, a scanner operable to scan veneer to determine the grade of veneer, the scanner comprising a scanner controller operable to provide the veneer clip signals to clip pieces of veneer of various grades, including trash grade veneer, fishtail grade veneer, random grade veneer and fourth grade veneer, the scanner controller also being operable to provide diverter control signals to the diverter controller indicating the timing that the respective diverters are to be positioned in the veneer flow path to divert pieces of veneer from the veneer flow path in response to the diverter control signals, the diverter controller providing the diverter motor control signals to the diverter motors so as to control the diverters to divert and sort the different categories of veneer; wherein as a piece of veneer that is of a better than trash grade veneer is reaching the first set of diverters, the first set of diverters are rotated by the first diverter motor out of the veneer flow path if not already out of the veneer flow path, and wherein the first set of diverters remain out of the veneer flow path until such time as the piece of veneer reaching the first set of diverters is no longer better than trash grade veneer and the first set of diverters are rotated by the first diverter motor into the veneer flow path, or retained in the veneer flow path if already in the veneer flow path, such that the first set of diverters are operable to divert veneer that is no longer better than trash grade veneer downwardly from the diverter belts and away from the veneer flow path; wherein as a piece of veneer that is of a better than fishtail grade veneer is reaching the second set of diverters, the second set of diverters are rotated by the second diverter motor out of the veneer flow path if not already out of the veneer flow path, wherein the second set of diverters remain out of the veneer flow path until such time as a piece of veneer reaching the second set of diverters is no longer better than fishtail grade veneer and the second set of diverters are rotated by the second diverter motor into the veneer flow path, or retained in the veneer flow path if already in the veneer flow path, such that the second set of diverters are operable to divert veneer that is no longer better than fishtail grade veneer downwardly from the diverter belts and away from the veneer flow path; wherein as a piece of veneer that is of a better than random grade veneer is reaching the third set of diverters, wherein the third set of diverters are rotated by the third diverter motor out of the veneer flow path if not already out of the veneer flow path, the third set of diverters remain out of the veneer flow path until such time as the piece of veneer reaching the third set of diverters is no longer better than random grade veneer and the third set of diverters are rotated by the third diverter motor into the veneer flow path, or retained in the veneer flow path if already in the veneer flow path, such that the third set of diverters are operable to divert veneer that is no longer better than random grade veneer downwardly from the diverter belts and away from the veneer flow path; wherein as a piece of veneer that is better than a fourth grade of veneer is reaching the fourth set of diverters, the fourth set of diverters are rotated by the fourth diverter motor out of the veneer flow path if not already out of the veneer flow path; wherein the fourth set of diverters remain out of the veneer flow path until such time as the piece of veneer reaching the fourth set of diverters is no longer better than the fourth grade of veneer and the fourth set of diverters are rotated by the fourth diverter motor into the veneer flow path, or retained in the veneer flow path if already in the veneer flow path, such that the fourth set of diverters are operable to divert veneer that is no longer better than the fourth grade of veneer downwardly from the diverter belts and away from the veneer flow path.

51. The apparatus according to paragraph 50, comprising a veneer scanner at an upstream location relative to the veneer flow direction from the diverter body and a veneer clipper intermediate to the veneer scanner and diverter body, the veneer flow path passing adjacent to the scanner such that veneer is positioned for scanning by the scanner, the scanner comprising a scanner controller coupled and operable to control cutting of veneer by the clipper and operable to receive signals from the clipper indicating the edge of the clipped veneer, the scanner controller also providing diverter control signals for controlling the timing of operation of the various sets of diverters to sort the categories of veneer, a diverter controller coupled to the scanner controller, the diverter controller also being coupled to the first, second and third diverter motors to control the diverter motor to control the movement of the veneer diverters, a belt mover controlled by the diverter controller and operable to move the belts such that the belts travel in the first veneer flow direction along the bottom portion of the diverter body in response to operation of the belt mover, belt speed information being communicated to the scanner controller such that the scanner controller is operable to track the position of the leading edge of the veneer clipped by the clipper along the veneer flow path, the scanner controller sending diverter control signals to the diverter controller indicating the timing at which the respective sets of diverters are to be rotated into the veneer flow path by the diverter controller in response to the diverter control signals to sort the veneer, the diverter controller, responsive to the diverter control signals, sending diverter motor control signals to cause the movement of the respective sets of veneer diverters into and out of the veneer flow path.

52. The apparatus according to paragraph 50 or 51, wherein there is at least one additional diverter support shaft rotatably coupled to the diverter body for rotating about an additional transverse diverter shaft axis and at least one additional set of plural spaced apart veneer diverters mounted to said one additional diverter support shaft, and an additional diverter motor coupled to said additional diverter support shaft for rotating said additional set of plural spaced apart veneer diverters into and out of the veneer flow path in response to veneer category control signals; comprising a pinch belt assembly at the first end portion of the diverter body and comprising plural pinch belts operable to urge veneer against the belts at least when the pinch belt assembly is in a first position, the pinch belt assembly being pivotally supported for pivoting movement between an operational position and at least one clearance position wherein the pinch belts are spaced further from the clipper than when the pinch belt assembly is in the operational position; and wherein there is at least one material conveyer associated with each set of diverters and positioned to receive material diverted from the veneer flow path by the associated diverters.

53. The apparatus according to paragraph 52, wherein each diverter comprises at least two diverter projections with each diverter projection comprising a distal end portion and being configured such that the angle of entry between the veneer engaging surface at the distal end portion of each diverter projection and the veneer flow path is about 90 degrees when the distal end portion rotates into the veneer flow path, and wherein the diverters comprise a generally S-shaped diverter body comprising first and second diverter projections.

54. The apparatus according to paragraph 53, comprising first and second sets of suspension supports extending upwardly from the top portion of the diverter body, a first set of suspension supports being positioned nearer to the first end portion of the diverter body than the second end portion of the diverter body and the second set of suspension supports being positioned nearer to the second end portion of the body than the first end portion of the diverter body, each of the suspension supports comprising a distal end portion spaced from the diverter body and a roller coupled to the distal end portion of the suspension support, the frame comprising a plurality of ramps, each ramp being associated with one of the rollers and comprising an upwardly inclined surface angled upwardly and away from the first end portion of the diverter body for rollingly receiving a respective associated one of the rollers, at least one pneumatic cylinder mounted to the frame and coupled to the diverter such that operation of the pneumatic cylinder in one direction moves each of the rollers along the associated ramp to thereby move the diverter body and operation of the at least one pneumatic cylinder in the opposite direction moves each of the rollers downwardly along the ramp, at least one catch pivotally mounted to the frame and positioned so as to pivot toward and away from an associated ramp, the catch having a plurality of downwardly facing teeth and being shaped and positioned such that as a roller moves upwardly along the ramp associated with the at least one catch, the teeth engage the roller to prevent the roller from moving downwardly until such time as the catch is pivoted away from the ramp.

55. The apparatus of paragraph 1, wherein first and second ends of the belt are coupled to one another to provide a continuous belt.

56. The method according to paragraph 12, wherein first and second ends of the belt are coupled to one another to provide a continuous belt.

57. A system for transporting a wood veneer, comprising: a frame; a diverter body supported by the frame, the diverter body comprising: a plurality of diverter belts coupled thereto and supported thereabout for travel in a veneer flow direction along a bottom portion of the diverter body, wherein the diverter belts each comprise a plurality of spikes extending from a first side of the belt, wherein the plurality of spikes are configured to detachably engage with one or more pieces of veneer and transport the one or more pieces of veneer along the bottom portion of the diverter body in a veneer flow path along the veneer flow direction, the belts being spaced apart transversely relative to the veneer flow direction; at least one set of veneer engaging diverters spaced apart with respect to one another, the at least one set of veneer engaging diverters being rotatably coupled to the diverter body for rotating about a diverter axis that is transverse to the veneer flow direction, the diverter axis being positioned above the veneer flow path, wherein each veneer engaging diverter comprises at least one diverter projection rotatable into and rotatable out of the veneer flow path, wherein the diverter projection rotates in the veneer flow direction, the diverter projection being operable such that, when the diverter projection is rotated into the veneer flow path the diverter projection engages at least one piece of veneer traveling in the veneer flow direction such that the diverter projection diverts the engaged piece of veneer from the plurality of diverter belts and out of the veneer flow path; and at least one conveyor adapted to receive the diverted piece of veneer.

58. The system according to paragraph 57, wherein the diverter body comprises at least two sets of veneer engaging diverters spaced apart along the veneer flow direction with respect to one another, and wherein the diverter body comprises a first conveyor adapted to receive a first piece of veneer diverted from the plurality of belts by the first set of veneer engaging diverters and a second conveyor adapted to receive a second piece of veneer diverted from the plurality of belts by the second set of veneer engaging diverters.

59. The system according to paragraph 58, wherein the first and second pieces of veneer are assigned to different categories of veneer with respect to one another.

60. The system according to paragraph 59, wherein the different categories of veneer comprise trash veneer, fishtail veneer, random veneer, wet full sheet veneer, and dry full sheet veneer.

61. The system according to paragraph 57, wherein the diverter body comprises at least three sets of veneer engaging diverters spaced apart along the veneer flow direction with respect to one another, and wherein the diverter body comprises a first conveyor adapted to receive a first piece of veneer diverted from the plurality of belts by the first set of veneer engaging diverters, a second conveyor adapted to receive a second piece of veneer diverted from the plurality of belts by the second set of veneer engaging diverters, and a third conveyor adapted to receive a third piece of veneer diverted from the plurality of belts by the third set of veneer engaging diverters.

62. The system according to paragraph 61, wherein the first, second, and third pieces of veneer are assigned to different categories of veneer with respect to one another.

63. The system according to paragraph 62, wherein the different categories of veneer comprise trash veneer, fishtail veneer, random veneer, wet full sheet veneer, and dry full sheet veneer.

64. The system according to paragraph 57, wherein the diverter body comprises at least four sets of veneer engaging diverters spaced apart along the veneer flow direction with respect to one another, and wherein the diverter body comprises a first conveyor adapted to receive a first piece of veneer diverted from the plurality of belts by the first set of veneer engaging diverters, a second conveyor adapted to receive a second piece of veneer diverted from the plurality of belts by the second set of veneer engaging diverters, a third conveyor adapted to receive a third piece of veneer diverted from the plurality of belts by the third set of veneer engaging diverters, and a fourth conveyor adapted to receive a fourth piece of veneer diverted from the plurality of belts by the fourth set of veneer engaging diverters.

65. The system according to paragraph 64, wherein the first, second, third, and fourth pieces of veneer are assigned to different categories of veneer with respect to one another.

66. The system according to paragraph 65, wherein the different categories of veneer comprise trash veneer, fishtail veneer, random veneer, wet full sheet veneer, and dry full sheet veneer.

67. The system according to paragraph 57, wherein the diverter body comprises at least five sets of veneer engaging diverters spaced apart along the veneer flow direction with respect to one another, and wherein the diverter body comprises a first conveyor adapted to receive a first piece of veneer diverted from the plurality of belts by the first set of veneer engaging diverters, a second conveyor adapted to receive a second piece of veneer diverted from the plurality of belts by the second set of veneer engaging diverters, a third conveyor adapted to receive a third piece of veneer diverted from the plurality of belts by the third set of veneer engaging diverters, a fourth conveyor adapted to receive a fourth piece of veneer diverted from the plurality of belts by the fourth set of veneer engaging diverters, and a fifth conveyor adapted to receive a fifth piece of veneer diverted from the plurality of belts by the fifth set of veneer engaging diverters.

68. The system according to paragraph 67, wherein the first, second, third, fourth, and fifth pieces of veneer are assigned to different categories of veneer with respect to one another.

69. The system according to paragraph 68, wherein the different categories of veneer comprise trash veneer, fishtail veneer, random veneer, wet full sheet veneer, and dry full sheet veneer.

70. The system according to paragraph 57, wherein the diverter body comprises at least six sets of veneer engaging diverters spaced apart along the veneer flow direction with respect to one another, and wherein the diverter body comprises a first conveyor adapted to receive a first piece of veneer diverted from the plurality of belts by the first set of veneer engaging diverters, a second conveyor adapted to receive a second piece of veneer diverted from the plurality of belts by the second set of veneer engaging diverters, a third conveyor adapted to receive a third piece of veneer diverted from the plurality of belts by the third set of veneer engaging diverters, a fourth conveyor adapted to receive a fourth piece of veneer diverted from the plurality of belts by the fourth set of veneer engaging diverters, a fifth conveyor adapted to receive a fifth piece of veneer diverted from the plurality of belts by the fifth set of veneer engaging diverters, and a sixth conveyor adapted to receive a sixth piece of veneer diverted from the plurality of belts by the sixth set of veneer engaging diverts.

71. The system according to paragraph 70, wherein the first, second, third, fourth, fifth, and sixth pieces of veneer are assigned to different categories of veneer with respect to one another.

72. The system according to paragraph 71, wherein the different categories of veneer comprise trash veneer, fishtail veneer, first random veneer, second random veneer, wet full sheet veneer, and dry full sheet veneer.

73. The system according to any one of paragraphs 57 to 72, wherein the diverter projection comprises a veneer engaging surface that does not lie entirely in a single plane.

74. The system according to any one of paragraphs 57 to 73, wherein the diverter projections of each veneer engaging diverter is stoppable within the veneer flow path.

75. The system according to any one of paragraphs 57 to 74, wherein each spike is disposed through an aperture defined by the belt.

76. The system according to any one of paragraphs 57 to 75, wherein each spike comprises a base, a shank extending from the base, an impaling portion extending from the shank and terminating at an end.

77. The system according to paragraph 76, wherein the shank comprises one or more threads disposed on an outer surface thereof, wherein the base is adjacent the second side of the belt and a nut is threadably engaged with at least a portion of the one or more threads about the first side of the belt such that the belt is located between the base and the nut.

78. The system according to any one of paragraphs 57 to 77, wherein each spike extends from the first side of the belt a length ranging from about 0.5 cm to about 4 cm.

79. The system according to any one of paragraphs 57 to 78, wherein the plurality of spikes are longitudinally disposed along a length of the belt, and wherein any two adjacent spikes are located a distance ranging from about 3.5 cm to about 6.5 cm from one another.

80. The system according to any one of paragraphs 57 to 79, wherein first and second ends of the belt are coupled to one another to provide a continuous belt.

The system according to any one of paragraphs 19 to 31, wherein the veneer transporting diverter belts each comprise a plurality of spikes extending from a first side of the belt, wherein the plurality of spikes are configured to detachably engage with the pieces of veneer.

Throughout this disclosure, when a reference is made to a first element being coupled to a second element, the term “coupled” is to be construed to mean both direct connection of the elements as well as indirect connection of the elements by way of one or more additional intervening elements. Also, the singular terms “a”, “and”, and “first”, mean both the singular and the plural unless the term is qualified to expressly indicate that it only refers to a singular element, such as by using the phase “only one”. Thus, for example, if two of a particular element are present, there is also “a” or “an” of such element that is present. In addition, the term “and/or” when used in this document is to be construed to include the conjunctive “and”, the disjunctive “or”, and both “and” and “or”. Also, the term includes has the same meaning as can include.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, any patents, test procedures, and other documents cited in this application are fully incorporated by reference to the extent such disclosure is not inconsistent with this application and for all jurisdictions in which such incorporation is permitted.

The terms “up” and “down”; “upward” and “downward”; “upper” and “lower”; “upwardly” and “downwardly”; “upstream” and “downstream”; “above” and “below”; and other like terms as used herein refer to relative positions to one another and are not intended to denote a particular spatial orientation.

While the foregoing is directed to embodiments of the present invention, other and further embodiments of the invention can be devised without departing from the basic scope thereof, and the scope thereof is determined by the claims that follow.

What is claimed is:

1. An apparatus for transporting a wood veneer, comprising:
a belt; and
a plurality of spikes extending from a first side of the belt, wherein the plurality of spikes are configured to detachably engage with a wood veneer.
